(19) United States
(12) Patent Application Publication
(10) Pub. No.: US 2024/0255094 A1
(43) Pub. Date: Aug. 1, 2024

(54) BINDER-MEDIATED CUTABILITY OF INSULATION PRODUCTS

(71) Applicant: Knauf Insulation, Inc., Shelbyville, IN (US)

(72) Inventors: Christopher George HARDY, Greensburg, IN (US); John Phillip WADE, Shelbyville, IN (US); Brian Lee SWIFT, Oxford, GA (US)

(21) Appl. No.: 18/425,348

(22) Filed: Jan. 29, 2024

Related U.S. Application Data
(60) Provisional application No. 63/442,173, filed on Jan. 31, 2023.

(51) Int. Cl. F16L 59/02; C08K 5/5419; C08K 7/14; F16L 59/14; G10K 11/162

(52) U.S. Cl. CPC F16L 59/028; C08K 5/5419; C08K 7/14; F16L 59/14; G10K 11/162

(57) ABSTRACT

A method of fabricating thermal and/or acoustical insulation products including glass fibers and formaldehyde-free, substantially water-insoluble, thermoset resin binders, which binders afford thermal and/or acoustical insulation products requiring less cutting force during fabrication and promote greater wearability, durability, and/or longevity for cutting blades used in fabrication.

### CROSS-REFERENCE TO RELATED APPLICATION

This application claims priority under 35 U.S.C. § 119(e) to U.S. Provisional Application Ser. No. 63/442,173, filed Jan. 31, 2023, the disclosure of which is hereby incorporated herein by reference.

### FIELD OF THE INVENTION

The invention relates to methods and materials for building construction and, in particular, to a method of fabricating thermal and/or acoustical insulation products comprising glass fibers and formaldehyde-free, substantially water-insoluble thermoset resin binders.

### BACKGROUND

Formaldehyde-free binders are useful in the manufacture of thermal and/or acoustical insulation products. During fabrication of such products, which, of necessity, involves a series of manipulations including actual cutting of insulation material, perceived cutability issues may arise such as tearing and/or clumping of material during the cutting process. The problem is essentially two-fold in that, when cutability issues arise with thermal and/or acoustical insulation products manufactured with particular formaldehyde-free binders, the blades used to cut/fabricate such products, which generally work, i.e., cut, well when they are new, tend to wear out faster than identical blades used to cut/fabricate the same products manufactured with a phenol-formaldehyde (PF) binder. For example, a new blade used to fabricate a thermal and/or acoustical insulation product manufactured with a particular formaldehyde-free binder may only have 15-30% of the blade-life of an identical blade used to fabricate the same product manufactured with a PF binder. As a result, additional expense due to frequent blade replacement may be incurred during fabrication of thermal and/or acoustical insulation products manufactured with certain formaldehyde-free binders.

Rather than rely on a metallurgical solution to cutability issues, which would involve investigating new blade materials and/or metal alloy development for the actual blades used to cut insulation material during the fabrication process, or on continued fabrication of thermal and/or acoustical insulation products manufactured with PF binders, which binders are under increased scrutiny for their impact on the environment and/or on human health, a binder-mediated solution to cutability issues is desirable.

### SUMMARY

In accordance with one of its aspects, the present invention provides a method of fabricating a thermal or acoustical insulation product as defined in independent claim 1. Preferred and/or alternative embodiments are defined in the dependent claims. In another aspect, it should be appreciated that the present invention may be utilized in a variety of fabrication applications, which involve cutting a thermal or acoustical insulation product with a blade and forming the cut thermal or acoustical insulation product into a desired structure (for example, in a GlassMaster® Duct Board Grooving Machine, now sold by CertainTeed's Machine Works group). One feature of the binders used in the present invention is that they are cured; another feature is that they are formaldehyde-free. Accordingly, the materials the binders are disposed upon, i.e., thermal or acoustical insulation products, may also be formaldehyde free.

In another aspect, the binders used in the present invention include at least one product of a Maillard reaction. As shown in FIG. 2, Maillard reactions produce melanoidins, i.e., substantially water-insoluble, high molecular weight, furan ring- and nitrogen-containing polymers that vary in structure depending on the reactants and conditions of their preparation. Melanoidins display a C:N ratio, degree of unsaturation, and chemical aromaticity that increase with temperature and time of heating. (See, Ames, J. M. in “The Maillard Browning Reaction—an update,” Chemistry and Industry (Great Britain), 1988, 7, 558-561, the disclosure of which is hereby incorporated herein by reference). The binders used in the present invention may be made via a Maillard reaction and thus contain melanoidins. Moreover, the binders used in the present invention may be thermoset binders.

The Maillard reactants to produce a melanoidin may include an amine reactant reacted with a reducing-sugar carbohydrate reactant. For example, as shown in FIG. 1, an ammonium salt of a monomeric polycarboxylic acid may be reacted with (i) a monosaccharide in its aldose or ketose form or (ii) a polysaccharide that yields one or more reducing sugars in situ under thermal curing conditions, or (iii) with combinations thereof. In another variation, an ammonium salt of a polymeric polycarboxylic acid may be contacted with (i) a monosaccharide in its aldose or ketose form or (ii) a polysaccharide that yields one or more reducing sugars in situ under thermal curing conditions, or (iii) with combinations thereof.

It should also be appreciated that the binders used in the present invention may include melanoidins produced in non-sugar variants of Maillard reactions. In these reactions, which are shown in FIG. 1, an amine reactant is contacted with a non-carbohydrate carbonyl reactant. In one illustrative variation, an ammonium salt of a monomeric polycarboxylic acid is contacted with a non-carbohydrate carbonyl reactant such as pyruvaldehyde, acetaldehyde, crotonaldehyde, 2-furaldehyde, quinone, ascorbic acid, or the like, or with combinations thereof. In another illustrative variation, an ammonium salt of a polymeric polycarboxylic acid may be contacted with a non-carbohydrate carbonyl reactant such as pyruvaldehyde, acetaldehyde, crotonaldehyde, 2-furaldehyde, quinone, ascorbic acid, or the like, or with combinations thereof.

The melanoidins discussed herein may be generated from melanoidin reactant compounds (i.e., Maillard reactants). These reactant compounds are disposed, i.e., applied, in an aqueous solution at an alkaline pH and therefore are not corrosive. That is, the alkaline solution prevents or inhibits the eating or wearing away of a substance, such as metal, caused by chemical decomposition brought about by, for example, an acid. Melanoidin reactant compounds may include a reducing-sugar carbohydrate reactant and an amine reactant. Alternatively, melanoidin reactant compounds may include a non-carbohydrate carbonyl reactant and an amine reactant.

One illustrative embodiment of the present invention is directed to a method of fabricating air duct board, i.e., a thermal or acoustical fiberglass insulation product, wherein the product comprises glass fibers and a cured binder as described herein. Illustratively, the cured binder includes at least one Maillard reaction product of an amine reactant and a carbohydrate reactant exemplified by an ammonium salt of a monomeric polycarboxylic acid and a reducing sugar, respectively.

Additional features of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

FIG. 1 shows a number of illustrative reactants for producing melanoidins;

FIG. 2 illustrates a Maillard reaction scheme;

FIG. 3 shows an exemplary schematic for disposing a binder onto fibers; and

FIG. 4 shows Blade Wear Analysis—Cutability Results as a function of binder type on air duct board.

### DETAILED DESCRIPTION

While the invention is susceptible to various modifications and alternative forms, specific embodiments will herein be described in detail. It should be understood, however, that there is no intent to limit the invention to the particular forms described, but on the contrary, the intention is to cover all modifications, equivalents, and alternatives falling within the spirit and scope of the invention.

It has been found that binders used in the present invention, which are based, inter alia, on a combination of a carbohydrate and, for example, an ammonium salt of one or more polycarboxylic acids, unexpectedly impart cutability (properties) to thermal and/or acoustical insulation products that is not only comparable to the cutability (properties) exhibited by such products manufactured with phenol-formaldehyde (PF) binders, but also improved compared to, for example, the cutability (properties) of such products manufactured with binders embodied in the inorganic acid/ammonium salt-carbohydrate system of WO 2009/019235. WO 2009/019235 teaches binders based, inter alia, on a combination of a carbohydrate, ammonia, and an inorganic acid (for example, phosphoric acid). Both for the binders used in the present invention as well as the binders taught in WO 2009/019235, a Maillard reaction and/or Maillard-type reaction forms the basis of the curing chemistry. Accordingly, it would have been thought that the polymeric products of the Maillard/Maillard-type curing chemistry, i.e., substantially water-insoluble, high molecular weight, furan ring- and nitrogen-containing melanoidins, would have a significant, if not a determinant, effect upon the properties of the cured binder. It is thus surprising that, compared to chemically distinct PF binders and to binders in the arguably similar binder system of WO 2009/019235, the binders used in the present invention should impart comparable and demonstrably improved cutability (properties), respectively, to thermal and/or acoustical insulation products.

Without wishing to be bound by theory regarding a mechanism for improved cutability, which is manifested in greater wearability, durability, and/or longevity of cutting blades used in fabrication, it is believed that, compared to the polymeric melanoidin binder matrix established via the binders described in WO 2009/019235, the polymeric melanoidin binder matrix established via the cured binders used in the present invention may be inherently less corrosive to a cutting blade per se and/or associated with a modulus that impacts how bound fibers break as a cutting blade passes through a thermal and/or acoustical insulation product.

In accordance with one of its aspects, the present invention provides a method of fabricating a thermal or acoustical insulation product, the method comprising:
cutting the thermal or acoustical insulation product with a single cutting blade, wherein the insulation product maintains a cutability rating of about 1 to about 2; and
forming the cut thermal or acoustical insulation product into a desired structure or space,
wherein the thermal or acoustical insulation product comprises:
(a) a collection of glass fibers, the glass fibers being present in the insulation product in the range from about 80% by weight to about 99% by weight; and
(b) a cured, formaldehyde-free binder disposed on the collection of glass fibers, wherein the cured binder comprises i) at least one Maillard reaction product of a carbohydrate reactant and an amine reactant, wherein the carbohydrate reactant is selected from one or more carbohydrate reactants having one or more reducing sugars, one or more carbohydrate reactants which yield one or more reducing sugars in situ under thermal curing conditions, and combinations thereof, wherein the amine reactant is selected from an ammonium salt of one or more monomeric polycarboxylic acids, an ammonium salt of one or more polymeric polycarboxylic acids, and combinations thereof, and wherein the percent by dry weight of the reducing sugar from the carbohydrate reactant with respect to the total weight of reactants ranges from about 73% to about 96%, ii) a silicon-containing coupling agent, and iii) optionally, a corrosion inhibitor,
and wherein the thermal or acoustical insulation product has a density of from about 0.4 lbs/ft³ to about 6 lbs/ft³.

As used herein, the phrase “cutability rating” refers to the cleanness or smoothness of a cut represented by a number ranging from 1 to 4, where 1=Good, 2=Minimal, 3=Significant, and 4=Severe. For example, a rating of 1 or “Good” denotes a completely smooth cut, i.e., where minimal fuzz or stray fiber is present within clean, crisp channels cut into an insulation product. A “Severe” rating of 4 denotes a very ragged edge that is aesthetically objectionable.

As used herein, the phrase “formaldehyde-free” means that a binder or a material that incorporates a binder liberates less than about 1 ppm formaldehyde as a result of drying and/or curing. The 1 ppm is based on the weight of sample being measured for formaldehyde release.

As used herein, “cured” indicates that the binder has been exposed to conditions so as to initiate a chemical change. Examples of these chemical changes include, but are not limited to, (i) covalent bonding, (ii) hydrogen bonding of binder components, and (iii) chemically cross-linking the polymers and/or oligomers in the binder. These changes may increase the binder's durability and solvent resistance as compared to the uncured binder. Curing a binder may result in the formation of a thermoset material. Furthermore, curing may include the generation of melanoidins. These melanoidins may be generated from a Maillard reaction from melanoidin reactant compounds. In addition, a cured binder may result in an increase in adhesion between the matter in a collection as compared to an uncured binder. Curing can be initiated by, for example, heat, microwave radiation, and/or conditions that initiate one or more of the chemical changes mentioned above.

In a situation where the chemical change in the binder results in the release of water, e.g., polymerization and cross-linking, a cure can be determined by the amount of water released above that which would occur from drying alone. The techniques used to measure the amount of water released during drying as compared to when a binder is cured, are well known in the art.

As used herein, the term “alkaline” indicates a solution having a pH that is greater than or equal to about 7. For example, the pH of the solution can be less than or equal to about 10. In addition, the solution may have a pH from about 7 to about 10, or from about 8 to about 10, or from about 9 to about 10.

As used herein, the term “ammonium” includes, but is not limited to, ⁺NH₄, ⁺NH₃R¹, and ⁺NH₂R¹R², where R¹ and R² are each independently selected in ⁺NH₂R¹R², and where R¹ and R² are selected from alkyl, cycloalkyl, alkenyl, cycloalkenyl, heterocyclyl, aryl, and heteroaryl.

The term “alkyl” as used herein refers to a saturated monovalent chain of carbon atoms, which may be optionally branched; the term “cycloalkyl” refers to a monovalent chain of carbon atoms, a portion of which forms a ring; the term “alkenyl” refers to an unsaturated monovalent chain of carbon atoms including at least one double bond, which may be optionally branched; the term “cycloalkenyl” refers to an unsaturated monovalent chain of carbon atoms, a portion of which forms a ring; the term “heterocyclyl” refers to a monovalent chain of carbon and heteroatoms, wherein the heteroatoms are selected from nitrogen, oxygen, and sulfur, a portion of which, including at least one heteroatom, form a ring; the term “aryl” refers to an aromatic mono or polycyclic ring of carbon atoms, such as phenyl, naphthyl, and the like; and the term “heteroaryl” refers to an aromatic mono or polycyclic ring of carbon atoms and at least one heteroatom selected from nitrogen, oxygen, and sulfur, such as pyridinyl, pyrimidinyl, indolyl, benzoxazolyl, and the like. It is to be understood that each of alkyl, cycloalkyl, alkenyl, cycloalkenyl, and heterocyclyl may be optionally substituted with independently selected groups such as alkyl, haloalkyl, hydroxyalkyl, aminoalkyl, carboxylic acid and derivatives thereof, including esters, amides, and nitriles, hydroxy, alkoxy, acyloxy, amino, alkyl and dialkylamino, acylamino, thio, and the like, and combinations thereof. It is further to be understood that each of aryl and heteroaryl may be optionally substituted with one or more independently selected substituents, such as halo, hydroxy, amino, alkyl or dialkylamino, alkoxy, alkylsulfonyl, cyano, nitro, and the like.

As used herein, the term “polycarboxylic acid” indicates a dicarboxylic, tricarboxylic, tetracarboxylic, pentacarboxylic, and like monomeric polycarboxylic acids, and anhydrides, and combinations thereof, as well as polymeric polycarboxylic acids, anhydrides, copolymers, and combinations thereof. In one aspect, the polycarboxylic acid ammonium salt reactant is sufficiently non-volatile to maximize its ability to remain available for reaction with the carbohydrate reactant of a Maillard reaction (discussed below). In another aspect, the polycarboxylic acid ammonium salt reactant may be substituted with other chemical functional groups.

Illustratively, a monomeric polycarboxylic acid may be a dicarboxylic acid, including, but not limited to, unsaturated aliphatic dicarboxylic acids, saturated aliphatic dicarboxylic acids, aromatic dicarboxylic acids, unsaturated cyclic dicarboxylic acids, saturated cyclic dicarboxylic acids, hydroxy-substituted derivatives thereof, and the like. Or, illustratively, the polycarboxylic acid itself may be a tricarboxylic acid, including, but not limited to, unsaturated aliphatic tricarboxylic acids, saturated aliphatic tricarboxylic acids, aromatic tricarboxylic acids, unsaturated cyclic tricarboxylic acids, saturated cyclic tricarboxylic acids, hydroxy-substituted derivatives thereof, and the like. It is appreciated that any such polycarboxylic acids may be optionally substituted, such as with hydroxy, halo, alkyl, alkoxy, and the like. In one variation, the polycarboxylic acid is the saturated aliphatic tricarboxylic acid, citric acid. Other suitable polycarboxylic acids are contemplated to include, but are not limited to, aconitic acid, adipic acid, azelaic acid, butane tetracarboxylic acid dihydride, butane tricarboxylic acid, chlorendic acid, citraconic acid, dicyclopentadiene-maleic acid adducts, diethylenetriamine pentaacetic acid, adducts of dipentene and maleic acid, ethylenediamine tetraacetic acid (EDTA), fully maleated rosin, maleated tall-oil fatty acids, fumaric acid, glutaric acid, isophthalic acid, itaconic acid, maleated rosin oxidized with potassium peroxide to alcohol then carboxylic acid, maleic acid, malic acid, mesaconic acid, biphenol A or bisphenol F reacted via the KOLBE-Schmidt reaction with carbon dioxide to introduce 3-4 carboxyl groups, oxalic acid, phthalic acid, sebacic acid, succinic acid, tartaric acid, terephthalic acid, tetrabromophthalic acid, tetrachlorophthalic acid, tetrahydrophthalic acid, trimellitic acid, trimesic acid, and the like, and anhydrides, and combinations thereof.

Illustratively, a polymeric polycarboxylic acid may be an acid, including, but not limited to, polyacrylic acid, polymethacrylic acid, polymaleic acid, and like polymeric polycarboxylic acids, anhydrides thereof, and mixtures thereof, as well as copolymers of acrylic acid, methacrylic acid, maleic acid, and like carboxylic acids, anhydrides thereof, and mixtures thereof. Examples of commercially available polyacrylic acids include AQUASET-529 (Rohm & Haas, Philadelphia, PA, USA), CRITERION 2000 (Kemira, Helsinki, Finland, Europe), NF1 (H.B. Fuller, St. Paul, MN, USA), and SOKALAN (BASF, Ludwigshafen, Germany, Europe). With respect to SOKALAN, this is a water-soluble polyacrylic copolymer of acrylic acid and maleic acid, having a molecular weight of approximately 4000. AQUASET-529 is a composition containing polyacrylic acid cross-linked with glycerol, also containing sodium hypophosphite as a catalyst. CRITERION 2000 is an acidic solution of a partial salt of polyacrylic acid, having a molecular weight of approximately 2000. With respect to NF1, this is a copolymer containing carboxylic acid functionality and hydroxy functionality, as well as units with neither functionality; NF1 also contains chain transfer agents, such as sodium hypophosphite or organophosphate catalysts.

Further, compositions including polymeric polycarboxylic acids are also contemplated to be useful in preparing the binders described herein, such as those compositions described in U.S. Pat. Nos. 5,318,990, 5,661,213, 6,136,916, and 6,331,350, the disclosures of which are hereby incorporated herein by reference. Described in U.S. Pat. Nos. 5,318,990 and 6,331,350 are compositions comprising an aqueous solution of a polymeric polycarboxylic acid, a polyol, and a catalyst.

As described in U.S. Pat. Nos. 5,318,990 and 6,331,350, the polymeric polycarboxylic acid comprises an organic polymer or oligomer containing more than one pendant carboxy group. The polymeric polycarboxylic acid may be a homopolymer or copolymer prepared from unsaturated carboxylic acids including, but not necessarily limited to, acrylic acid, methacrylic acid, crotonic acid, isocrotonic acid, maleic acid, cinnamic acid, 2-methylmaleic acid, itaconic acid, 2-methylitaconic acid, α,β-methyleneglutaric acid, and the like. Alternatively, the polymeric polycarboxylic acid may be prepared from unsaturated anhydrides including, but not necessarily limited to, maleic anhydride, itaconic anhydride, acrylic anhydride, methacrylic anhydride, and the like, as well as mixtures thereof. Methods for polymerizing these acids and anhydrides are well-known in the chemical art. The polymeric polycarboxylic acid may additionally comprise a copolymer of one or more of the aforementioned unsaturated carboxylic acids or anhydrides and one or more vinyl compounds including, but not necessarily limited to, styrene, α-methylstyrene, acrylonitrile, methacrylonitrile, methyl acrylate, ethyl acrylate, n-butyl acrylate, isobutyl acrylate, methyl methacrylate, n-butyl methacrylate, isobutyl methacrylate, glycidyl methacrylate, vinyl methyl ether, vinyl acetate, and the like. Methods for preparing these copolymers are well-known in the art. The polymeric polycarboxylic acids may comprise homopolymers and copolymers of polyacrylic acid. The molecular weight of the polymeric polycarboxylic acid, and in particular polyacrylic acid polymer, may be is less than 10000, less than 5000, or about 3000 or less. For example, the molecular weight may be 2000.

As described in U.S. Pat. Nos. 5,318,990 and 6,331,350, the polyol (in a composition including a polymeric polycarboxylic acid) contains at least two hydroxyl groups. The polyol should be sufficiently nonvolatile such that it will substantially remain available for reaction with the polymeric polycarboxylic acid in the composition during heating and curing operations. The polyol may be a compound with a molecular weight less than about 1000 bearing at least two hydroxyl groups such as, ethylene glycol, glycerol, pentaerythritol, trimethylol propane, sorbitol, sucrose, glucose, resorcinol, catechol, pyrogallol, glycollated ureas, 1,4-cyclohexane diol, diethanolamine, triethanolamine, and certain reactive polyols, for example, β-hydroxyalkylamides such as, for example, bis[N,N-di(β-hydroxyethyl)]adipamide, or it may be an addition polymer containing at least two hydroxyl groups such as, polyvinyl alcohol, partially hydrolyzed polyvinyl acetate, and homopolymers or copolymers of hydroxyethyl(meth)acrylate, hydroxypropyl(meth)acrylate, and the like.

As described in U.S. Pat. Nos. 5,318,990 and 6,331,350, the catalyst (in a composition including a polymeric polycarboxylic acid) is a phosphorous-containing accelerator which may be a compound with a molecular weight less than about 1000 such as, an alkali metal polyphosphate, an alkali metal dihydrogen phosphate, a polyphosphoric acid, and an alkyl phosphinic acid or it may be an oligomer or polymer bearing phosphorous-containing groups, for example, addition polymers of acrylic and/or maleic acids formed in the presence of sodium hypophosphite, addition polymers prepared from ethylenically unsaturated monomers in the presence of phosphorous salt chain transfer agents or terminators, and addition polymers containing acid-functional monomer residues, for example, copolymerized phosphoethyl methacrylate, and like phosphonic acid esters, and copolymerized vinyl sulfonic acid monomers, and their salts. The phosphorous-containing accelerator may be used at a level of from about 1% to about 40%, by weight based on the combined weight of the polymeric polycarboxylic acid and the polyol. A level of phosphorous-containing accelerator of from about 2.5% to about 10%, by weight based on the combined weight of the polymeric polycarboxylic acid and the polyol may be used. Examples of such catalysts include, but are not limited to, sodium hypophosphite, sodium phosphite, potassium phosphite, disodium pyrophosphate, tetrasodium pyrophosphate, sodium tripolyphosphate, sodium hexametaphosphate, potassium phosphate, potassium polymetaphosphate, potassium polyphosphate, potassium tripolyphosphate, sodium trimetaphosphate, and sodium tetrametaphosphate, as well as mixtures thereof.

Compositions including polymeric polycarboxylic acids described in U.S. Pat. Nos. 5,661,213 and 6,136,916 that are contemplated to be useful in preparing the binders described herein for use in the present invention comprise an aqueous solution of a polymeric polycarboxylic acid, a polyol containing at least two hydroxyl groups, and a phosphorous-containing accelerator, wherein the ratio of the number of equivalents of carboxylic acid groups to the number of equivalents of hydroxyl groups is from about 1:0.01 to about 1:3

As described in U.S. Pat. Nos. 5,661,213 and 6,136,916, the polymeric polycarboxylic acid may be a polyester containing at least two carboxylic acid groups or an addition polymer or oligomer containing at least two copolymerized carboxylic acid-functional monomers. The polymeric polycarboxylic acid is preferably an addition polymer formed from at least one ethylenically unsaturated monomer. The addition polymer may be in the form of a solution of the addition polymer in an aqueous medium such as, an alkali-soluble resin which has been solubilized in a basic medium; in the form of an aqueous dispersion, for example, an emulsion-polymerized dispersion; or in the form of an aqueous suspension. The addition polymer must contain at least two carboxylic acid groups, anhydride groups, or salts thereof. Ethylenically unsaturated carboxylic acids such as, methacrylic acid, acrylic acid, crotonic acid, fumaric acid, maleic acid, 2-methyl maleic acid, itaconic acid, 2-methyl itaconic acid, α,β-methylene glutaric acid, monoalkyl maleates, and monoalkyl fumarates; ethylenically unsaturated anhydrides, for example, maleic anhydride, itaconic anhydride, acrylic anhydride, and methacrylic anhydride; and salts thereof, at a level of from about 1% to 100%, by weight, based on the weight of the addition polymer, may be used. Additional ethylenically unsaturated monomers may include acrylic ester monomers including methyl acrylate, ethyl acrylate, butyl acrylate, 2-ethylhexyl acrylate, decyl acrylate, methyl methacrylate, butyl methacrylate, isodecyl methacrylate, hydroxyethyl acrylate, hydroxyethyl methacrylate, and hydroxypropyl methacrylate; acrylamide or substituted acrylamides; styrene or substituted styrenes; butadiene; vinyl acetate or other vinyl esters; acrylonitrile or methacrylonitrile; and the like. The addition polymer containing at least two carboxylic acid groups, anhydride groups, or salts thereof may have a molecular weight from about 300 to about 10,000,000. A molecular weight from about 1000 to about 250,000 may be used. When the addition polymer is an alkali-soluble resin having a carboxylic acid, anhydride, or salt thereof, content of from about 5% to about 30%, by weight based on the total weight of the addition polymer, a molecular weight from about 10,000 to about 100,000 may be utilized Methods for preparing these additional polymers are well-known in the art.

As described in U.S. Pat. Nos. 5,661,213 and 6,136,916, the polyol (in a composition including a polymeric polycarboxylic acid) contains at least two hydroxyl groups and should be sufficiently nonvolatile that it remains substantially available for reaction with the polymeric polycarboxylic acid in the composition during heating and curing operations. The polyol may be a compound with a molecular weight less than about 1000 bearing at least two hydroxyl groups, for example, ethylene glycol, glycerol, pentaerythritol, trimethylol propane, sorbitol, sucrose, glucose, resorcinol, catechol, pyrogallol, glycollated ureas, 1,4-cyclohexane diol, diethanolamine, triethanolamine, and certain reactive polyols, for example, β-hydroxyalkylamides, for example, bis-[N,N-di(β-hydroxyethyl)]adipamide, bis[N,N-di(β-hydroxypropyl)] azelamide, bis[N—N-di(β-hydroxypropyl)] adipamide, bis[N—N-di(β-hydroxypropyl)] glutaramide, bis[N—N-di(β-hydroxypropyl)] succinamide, and bis[N-methyl-N-(β-hydroxyethyl)] oxamide, or it may be an addition polymer containing at least two hydroxyl groups such as, polyvinyl alcohol, partially hydrolyzed polyvinyl acetate, and homopolymers or copolymers of hydroxyethyl (meth)acrylate, hydroxypropyl (meth)acrylate, and the like.

As described in U.S. Pat. Nos. 5,661,213 and 6,136,916, the phosphorous-containing accelerator (in a composition including a polymeric polycarboxylic acid) may be a compound with a molecular weight less than about 1000, such as an alkali metal hypophosphite salt, an alkali metal phosphite, an alkali metal polyphosphate, an alkali metal dihydrogen phosphate, a polyphosphoric acid, and an alkyl phosphinic acid, or it may be an oligomer or polymer bearing phosphorous-containing groups such as addition polymers of acrylic and/or maleic acids formed in the presence of sodium hypophosphite, addition polymers prepared from ethylenically unsaturated monomers in the presence of phosphorous salt chain transfer agents or terminators, and addition polymers containing acid-functional monomer residues such as, copolymerized phosphoethyl methacrylate, and like phosphonic acid esters, and copolymerized vinyl sulfonic acid monomers, and their salts. The phosphorous-containing accelerator may be used at a level of from about 1% to about 40%, by weight based on the combined weight of the polyacid and the polyol. A level of phosphorous-containing accelerator of from about 2.5% to about 10%, by weight based on the combined weight of the polyacid and the polyol, may be utilized.

As used herein, the term “amine reactant” includes, but is not limited to, an ammonium salt of a monomeric polycarboxylic acid, an ammonium salt of a polymeric polycarboxylic acid, ammonia, a primary amine, i.e., NH₂R¹, and a secondary amine, i.e., NHR¹R², where R¹ and R² are each independently selected in NHR¹R², and where R¹ and R² are selected from alkyl, cycloalkyl, alkenyl, cycloalkenyl, heterocyclyl, aryl, and heteroaryl, as defined herein. Illustratively, the amine reactant may be substantially volatile or substantially non-volatile under conditions sufficient to promote formation of a thermoset binder during thermal curing. Illustratively, the amine reactant may be a substantially volatile base, such as ammonia, ethylamine, diethylamine, dimethylamine, ethylpropylamine, hexamethylenediamine, and the like. Alternatively, the amine reactant may be a substantially non-volatile base, such as aniline, 1-naphthylamine, 2-naphthylamine, para-aminophenol, and the like.

As used herein, “reducing sugar” indicates one or more sugars that contain aldehyde groups, or that can isomerize, i.e., tautomerize, to contain aldehyde groups, which groups are reactive with an amino group under Maillard reaction conditions and which groups may be oxidized with, for example, Cu⁺² to afford carboxylic acids. It is also appreciated that any such carbohydrate reactant may be optionally substituted, such as with hydroxy, halo, alkyl, alkoxy, and the like. It is further appreciated that in any such carbohydrate reactant, one or more chiral centers are present, and that both possible optical isomers at each chiral center are contemplated to be included in the invention described herein. Further, it is also to be understood that various mixtures, including racemic mixtures, or other diastereomeric mixtures of the various optical isomers of any such carbohydrate reactant, as well as various geometric isomers thereof, may be used in one or more embodiments described herein.

As used herein, the term “heat-resistant fibers” indicates fibers suitable for withstanding elevated temperatures. Examples of such fibers include, but are not limited to, mineral fibers (e.g., rock fibers), aramid fibers, ceramic fibers, metal fibers, carbon fibers, polyimide fibers, certain polyester fibers, rayon fibers, mineral wool (e.g., glass wool or rock wool), and glass fibers. Illustratively, such fibers are substantially unaffected by exposure to temperatures above about 120° C.

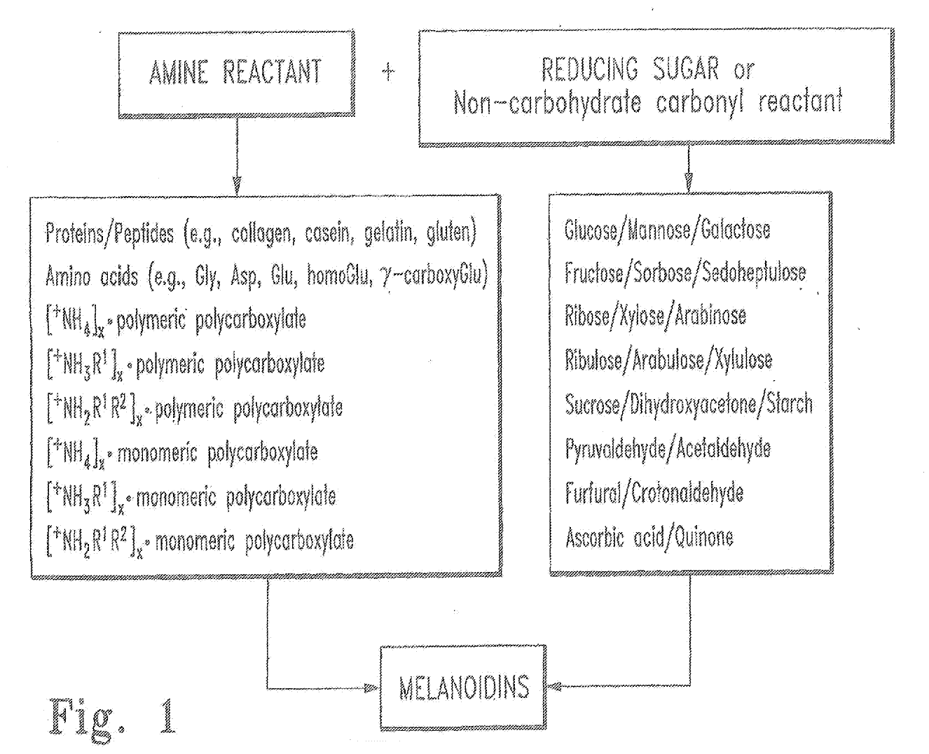

FIG. 1 shows examples of reactants for a Maillard reaction. However, amine reactants are not limited to proteins, peptides, amino acids, ammonium salts of polymeric polycarboxylic acids, and ammonium salts of monomeric polycarboxylic acids; rather, amine reactants also include ammonia, a primary amine, i.e., NH₂R¹, and a secondary amine, i.e., NHR¹R², where R¹ and R² are each independently selected in NHR¹R², and where R¹ and R² are selected from alkyl, cycloalkyl, alkenyl, cycloalkenyl, heterocyclyl, aryl, and heteroaryl, as described above. As illustrated in FIG. 1, “ammonium” can be [⁺NH₄]ₓ, [⁺NH₃R¹]ₓ, and [⁺NH₂R¹R²]ₓ, where x is at least about 1. With respect to ⁺NH₂R¹R², R¹ and R² are each independently selected. Moreover, R¹ and R² are selected from alkyl, cycloalkyl, alkenyl, cycloalkenyl, heterocyclyl, aryl, and heteroaryl, as described above. FIG. 1 also illustrates examples of reducing-sugar reactants for producing melanoidins, including monosaccharides, in their aldose or ketose form, polysaccharides, or combinations thereof. Illustrative non-carbohydrate carbonyl reactants for producing melanoidins are also shown in FIG. 1, and include various aldehydes, e.g., pyruvaldehyde and furfural, as well as compounds such as ascorbic acid and quinone.

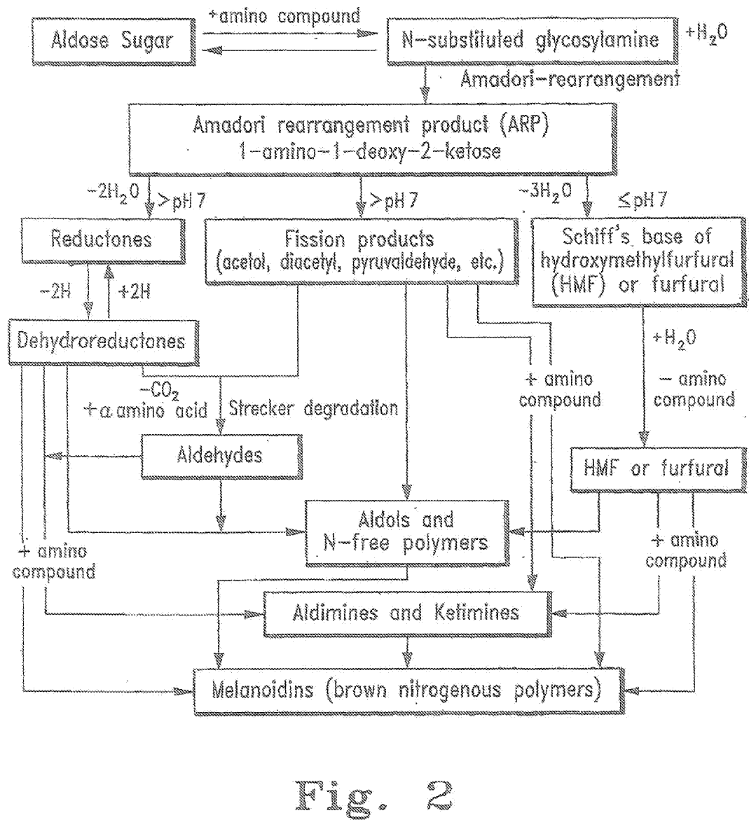

FIG. 2 shows a schematic of a Maillard reaction, which culminates in the production of melanoidins. In its initial phase, a Maillard reaction involves a carbohydrate reactant, for example, a reducing or aldose sugar (note that the carbohydrate reactant may come from a polysaccharide capable of producing a reducing sugar under Maillard reaction conditions). The reaction also involves condensing the carbohydrate reactant (e.g., a reducing or aldose sugar) with an amine reactant. In other words, the carbohydrate reactant and the amine reactant for a Maillard reaction are the melanoidin reactant compounds. The condensation of these two reactants produces an N-substituted glycosylamine. For a more detailed description of the Maillard reaction see, Hodge, J. E. Chemistry of Browning Reactions in Model Systems J. Agric. Food Chem. 1953, 1, 928-943, the disclosure of which is hereby incorporated herein by reference. The compound possessing a free amino group in a Maillard reaction, which compound serves as the amine reactant, may be present in the form of an amino acid. The free amino group can also come from a protein, where the free amino groups are available in the form of, for example, the ε-amino group of lysine residues, and/or the α-amino group of the terminal amino acid. Alternatively, as described herein, an ammonium salt of a polycarboxylic acid may serve as the amine reactant in a Maillard reaction.

Another aspect of conducting a Maillard reaction as described herein is that, initially, the aqueous Maillard reactant solution, as described above, has an alkaline pH. However, once the solution is disposed on a collection of non-assembled or loosely assembled matter, and curing is initiated, the pH decreases (i.e., the binder becomes acidic). It should be understood that when fabricating a material, the amount of contact between the binder and components of machinery used in the fabrication is greater prior to curing, (i.e., when the binder solution is alkaline) as compared to after the binder is cured (i.e., when the binder is acidic). An alkaline composition is less corrosive than an acidic composition. Accordingly, corrosivity of the fabrication process is decreased.

It should be appreciated that by using the aqueous Maillard reactant solution described herein, the machinery used to fabricate fiberglass is not exposed to an acidic solution because, as described above, the pH of the Maillard reactant solution is alkaline. Furthermore, during the fabrication process, the only time an acidic condition develops is after the binder has been applied to glass fibers. Once the binder is applied to the glass fibers, the binder and the material that incorporates the binder have relatively infrequent contact with the components of the machinery, as compared to the time prior to applying the binder to the glass fibers. Accordingly, corrosivity of fiberglass fabrication (and the fabrication of other materials) is decreased.

Without wishing to be bound to theory, covalent reaction of the polycarboxylic acid ammonium salt and reducing sugar reactants of a Maillard reaction, which as described herein occurs substantially during thermal curing to produce brown-colored nitrogenous polymeric and co-polymeric melanoidins of varying structure, is thought to involve initial Maillard reaction of ammonia with the aldehyde moiety of a reducing-sugar carbohydrate reactant to afford N-substituted glycosylamine, as shown in FIG. 2. Consumption of ammonia in such a way, with ammonia and a reducing-sugar carbohydrate reactant combination functioning as a latent acid catalyst, would be expected to result in a decrease in pH, which decrease is believed to promote esterification processes and/or dehydration of the polycarboxylic acid to afford its corresponding anhydride derivative. At pH≤7, the Amadori rearrangement product of N-substituted glycosylamine, i.e., 1-amino-1-deoxy-2-ketose, would be expected to undergo mainly 1,2-enolization with the formation of furfural when, for example, pentoses are involved, or hydroxymethylfurfural when, for example, hexoses are involved, as a prelude to melanoidin production. Concurrently, contemporaneously, or sequentially with the production of melanoidins, esterification processes may occur involving melanoidins, polycarboxylic acid and/or its corresponding anhydride derivative, and residual carbohydrate, which processes lead to extensive cross-linking. Accompanied by sugar dehydration reactions, whereupon conjugated double bonds are produced that may undergo polymerization, a substantially water-resistant thermoset binder is produced consisting of polyester adducts interconnected by a network of carbon-carbon single bonds.

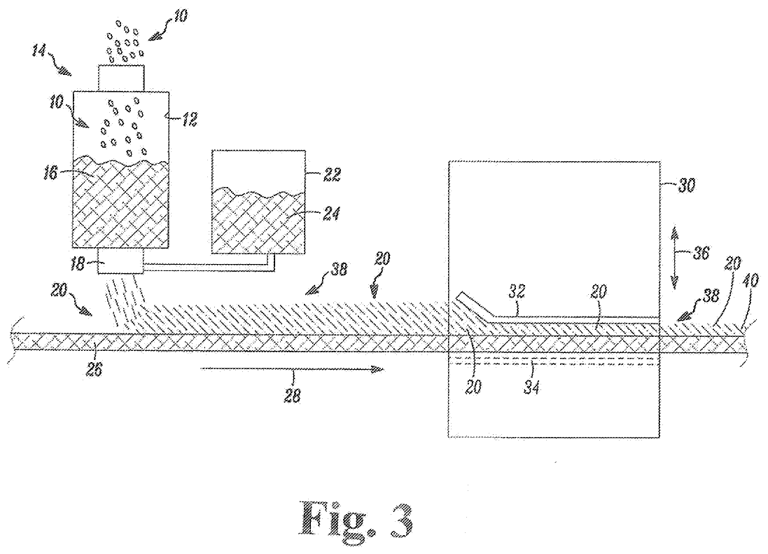

FIG. 3 is an exemplary schematic showing one embodiment of a process for disposing a binder used in the present invention onto a substrate such as glass fibers. In particular, as shown in FIG. 3, silica (sand) particles 10 are placed in the interior 12 of a vat 14, where the particles 10 are moltenized to produce molten glass 16. Molten glass 16 is then advanced through a fiberizer 18 so as to fiberize molten glass 16 into glass fibers 20. A container 22 that contains a liquid uncured binder 24 of the present invention is in fluid communication with fiberizer 18 and disposes the liquid uncured binder 24 onto glass fibers 20 so as to bind the fibers together. Glass fibers 20 are placed onto a forming chain 26 so as to form a collection 38 of glass fibers 20. The collection 38 is then advanced in the direction indicated by arrow 28 so as to enter oven 30 where the collection is heated, and curing occurs. While positioned in oven 30, collection 38 is positioned between flights 32 and 34. Flight 32 can be moved relative to flight 34 in the direction indicated by arrow 36, i.e., flight 32 can be positioned closer to flight 34 or moved away from flight 34 thereby adjusting the distance between flights 32 and 34. As shown in FIG. 7, flight 32 has been moved relative to flight 34 so as to exert a compressive force on collection 38 as it moves through the oven 30. Subjecting the collection 38 to a compressive force decreases the thickness of collection 38 as compared to its thickness prior to encountering flights 32 and 34. Accordingly, the density of the collection 38 is increased as compared to its density prior to encountering flights 32 and 34. As mentioned above, the collection 38 is heated in the oven 30 and curing occurs so as to produce a cured binder 40 being disposed on glass fibers 20. The curing may result in a thermoset binder material being disposed upon glass fibers 22. The collection 38 then exits oven 30 where it can be utilized in various products, e.g., products described herein, such as, acoustical board, pipe insulation, batt residential insulation, and elevated panel insulation to name a few.

The above description sets forth one example of how to adjust a process parameter to obtain one or more desirable physical/chemical characteristics of a collection bound together by a binder used in the present invention, e.g., the thickness and density of the collection is altered as it passes through the oven. However, it should be appreciated that a number of other parameters (one or more) can also be adjusted to obtain desirable characteristics. These include the amount of binder applied onto the glass fibers, the type of silica utilized to make the glass fibers, the size of the glass fibers (e.g., fiber diameter, fiber length and fiber thickness) that make up a collection. What the desirable characteristic are will depend upon the type of product being manufactured, e.g., air duct board, duct liner, and pipe insulation, to name a few. The desirable characteristics associated with any particular product are well known in the art. With respect to what process parameters to manipulate and how they are manipulated to obtain the desirable physical/chemical characteristics, e.g., thermal properties and acoustical characteristics, these can be determined by routine experimentation. For example, a collection having a greater density is desirable when fabricating air duct board as compared with the density required when fabricating residential insulation.

The following discussion is directed to (i) examples of carbohydrate and amine reactants, which reactants can be used in a Maillard reaction, (ii) how these reactants can be combined with each other and with various additives to prepare binders used in the present invention, and iii) illustrative embodiments of the binders described herein used as glass fiber binders in fiberglass insulation products.

With respect to exemplary reactants, it should be appreciated that using an ammonium salt of a polycarboxylic acid as an amine reactant is an effective reactant in a Maillard reaction. Ammonium salts of polycarboxylic acids can be generated by neutralizing the acid groups with an amine base, thereby producing polycarboxylic acid ammonium salt groups. Complete neutralization, i.e., about 100% calculated on an equivalents basis, may eliminate any need to titrate or partially neutralize acid groups in the polycarboxylic acid prior to binder formation. However, it is expected that less-than-complete neutralization would not inhibit formation of the binder. Note that neutralization of the acid groups of the polycarboxylic acid may be carried out either before or after the polycarboxylic acid is mixed with the carbohydrate.

With respect to the carbohydrate reactant, it may include one or more reactants having one or more reducing sugars, a reactant (e.g., a polysaccharide) that yields one or more reducing sugars in situ under thermal curing conditions, or combinations thereof. In one aspect, any carbohydrate reactant should be sufficiently nonvolatile to maximize its ability to remain available for reaction with the polycarboxylic acid ammonium salt reactant. The carbohydrate reactant may be a monosaccharide in its aldose or ketose form, including a triose, a tetrose, a pentose, a hexose, or a heptose; or a polysaccharide; or combinations thereof. A carbohydrate reactant may be a reducing sugar, or one that yields one or more reducing sugars in situ under thermal curing conditions. For example, when a triose serves as the carbohydrate reactant, or is used in combination with other reducing sugars and/or a polysaccharide, an aldotriose sugar or a ketotriose sugar may be utilized, such as glyceraldehyde and dihydroxyacetone, respectively. When a tetrose serves as the carbohydrate reactant or is used in combination with other reducing sugars and/or a polysaccharide, aldotetrose sugars, such as erythrose and threose; and ketotetrose sugars, such as erythrulose, may be utilized. When a pentose serves as the carbohydrate reactant or is used in combination with other reducing sugars and/or a polysaccharide, aldopentose sugars, such as ribose, arabinose, xylose, and lyxose; and ketopentose sugars, such as ribulose, arabulose, xylulose, and lyxulose, may be utilized. When a hexose serves as the carbohydrate reactant, or is used in combination with other reducing sugars and/or a polysaccharide, aldohexose sugars, such as glucose (i.e., dextrose), mannose, galactose, allose, altrose, talose, gulose, and idose; and ketohexose sugars, such as fructose, psicose, sorbose and tagatose, may be utilized. When a heptose serves as the carbohydrate reactant or is used in combination with other reducing sugars and/or a polysaccharide, a ketoheptose sugar such as sedoheptulose may be utilized. Other stereoisomers of such carbohydrate reactants not known to occur naturally are also contemplated to be useful in preparing the binder compositions as described herein. When a polysaccharide serves as the carbohydrate, or is used in combination with monosaccharides, sucrose, lactose, maltose, starch, and cellulose may be utilized.

Furthermore, the carbohydrate reactant in the Maillard reaction may be used in combination with a non-carbohydrate polyhydroxy reactant. Examples of non-carbohydrate polyhydroxy reactants which can be used in combination with the carbohydrate reactant include, but are not limited to, trimethylolpropane, glycerol, pentaerythritol, sorbitol, 1,5-pentanediol, 1,6-hexanediol, polyTHF650, polyTHF250, textrion whey, polyvinyl alcohol, partially hydrolyzed polyvinyl acetate, fully hydrolyzed polyvinyl acetate, and mixtures thereof. In one aspect, the non-carbohydrate polyhydroxy reactant is sufficiently nonvolatile to maximize its ability to remain available for reaction with a monomeric or polymeric polycarboxylic acid reactant. It is appreciated that the hydrophobicity of the non-carbohydrate polyhydroxy reactant may be a factor in determining the physical properties of a binder prepared as described herein.

When a partially hydrolyzed polyvinyl acetate serves as a non-carbohydrate polyhydroxy reactant, a commercially available compound such as an 87-89% hydrolyzed polyvinyl acetate may be utilized, such as, DuPont ELVANOL 51-05. DuPont ELVANOL 51-05 has a molecular weight of about 22,000-26,000 Da and a viscosity of about 5.0-6.0 centipoises. Other partially hydrolyzed polyvinyl acetates contemplated to be useful in preparing binder compositions as described herein include, but are not limited to, 87-89% hydrolyzed polyvinyl acetates differing in molecular weight and viscosity from ELVANOL 51-05, such as, for example, DuPont ELVANOL 51-04, ELVANOL 51-08, ELVANOL 50-14, ELVANOL 52-22, ELVANOL 50-26, ELVANOL 50-42; and partially hydrolyzed polyvinyl acetates differing in molecular weight, viscosity, and/or degree of hydrolysis from ELVANOL 51-05, such as, DuPont ELVANOL 51-03 (86-89% hydrolyzed), ELVANOL 70-14 (95.0-97.0% hydrolyzed), ELVANOL 70-27 (95.5-96.5% hydrolyzed), ELVANOL 60-30 (90-93% hydrolyzed). Other partially hydrolyzed polyvinyl acetates contemplated to be useful in preparing binder compositions as described herein include, but are not limited to, Clariant MOWIOL 15-79, MOWIOL 3-83, MOWIOL 4-88, MOWIOL 5-88, MOWIOL 8-88, MOWIOL 18-88, MOWIOL 23-88, MOWIOL 26-88, MOWIOL 40-88, MOWIOL 47-88, and MOWIOL 30-92, as well as Celanese CELVOL 203, CELVOL 205, CELVOL 502, CELVOL 504, CELVOL 513, CELVOL 523, CELVOL 523TV, CELVOL 530, CELVOL 540, CELVOL 540TV, CELVOL 418, CELVOL 425, and CELVOL 443. Also contemplated to be useful are similar or analogous partially hydrolyzed polyvinyl acetates available from other commercial suppliers.

When a fully hydrolyzed polyvinyl acetate serves as a non-carbohydrate polyhydroxy reactant, Clariant MOWIOL 4-98, having a molecular weight of about 27,000 Da, may be utilized. Other fully hydrolyzed polyvinyl acetates contemplated to be useful include, but are not limited to, DuPont ELVANOL 70-03 (98.0-98.8% hydrolyzed), ELVANOL 70-04 (98.0-98.8% hydrolyzed), ELVANOL 70-06 (98.5-99.2% hydrolyzed), ELVANOL 90-50 (99.0-99.8% hydrolyzed), ELVANOL 70-20 (98.5-99.2% hydrolyzed), ELVANOL 70-30 (98.5-99.2% hydrolyzed), ELVANOL 71-30 (99.0-99.8% hydrolyzed), ELVANOL 70-62 (98.4-99.8% hydrolyzed), ELVANOL 70-63 (98.5-99.2% hydrolyzed), ELVANOL 70-75 (98.5-99.2% hydrolyzed), Clariant MOWIOL 3-98, MOWIOL 6-98, MOWIOL 10-98, MOWIOL 20-98, MOWIOL 56-98, MOWIOL 28-99, and Celanese CELVOL 103, CELVOL 107, CELVOL 305, CELVOL 310, CELVOL 325, CELVOL 325LA, and CELVOL 350, as well as similar or analogous fully hydrolyzed polyvinyl acetates from other commercial suppliers.

The aforementioned Maillard reactants may be combined to make an aqueous composition that includes a carbohydrate reactant and an amine reactant. As discussed below, these aqueous compositions can be used to prepare binders for use in the present invention. Furthermore, as indicated above, the carbohydrate reactant of the Maillard reactants may be used in combination with a non-carbohydrate polyhydroxy reactant. Accordingly, any time the carbohydrate reactant is mentioned, it should be understood that it can be used in combination with a non-carbohydrate polyhydroxy reactant.

In one illustrative embodiment, an aqueous solution of Maillard reactants may include (i) an ammonium salt of a polycarboxylic acid reactant and (ii) a carbohydrate reactant having a reducing sugar. The pH of this solution prior to placing it in contact with the material to be bound can be greater than or equal to about 7. In addition, this solution can have a pH of less than or equal to about 10. The ratio of the number of moles of the polycarboxylic acid reactant to the number of moles of the carbohydrate reactant can be in the range from about 1:4 to about 1:15. In one illustrative variation, the ratio of the number of moles of the polycarboxylic acid reactant to the number of moles of the carbohydrate reactant in the binder composition is about 1:5. In another variation, the ratio of the number of moles of the polycarboxylic acid reactant to the number of moles of the carbohydrate reactant is about 1:6. In another variation, the ratio of the number of moles of the polycarboxylic acid reactant to the number of moles of the carbohydrate reactant is about 1:7.

As described above, an aqueous binder composition may include (i) an ammonium salt of a polycarboxylic acid reactant and (ii) a carbohydrate reactant having a reducing sugar. It should be appreciated that when an ammonium salt of a monomeric or a polymeric polycarboxylic acid is used as an amine reactant, the molar equivalents of ammonium ion may or may not be equal to the molar equivalents of acid groups present on the polycarboxylic acid. In one illustrative example, an ammonium salt may be monobasic, dibasic, or tribasic when a tricarboxylic acid is used as a polycarboxylic acid reactant. Thus, the molar equivalents of the ammonium ion may be present in an amount less than or about equal to the molar equivalents of acid groups present in a polycarboxylic acid. Accordingly, the ammonium salt can be monobasic or dibasic when the polycarboxylic acid reactant is a dicarboxylic acid. Further, the molar equivalents of ammonium ion may be present in an amount less than, or about equal to, the molar equivalents of acid groups present in a polymeric polycarboxylic acid, and so on and so forth. When a monobasic salt of a dicarboxylic acid is used, or when a dibasic salt of a tricarboxylic acid is used, or when the molar equivalents of ammonium ions are present in an amount less than the molar equivalents of acid groups present in a polymeric polycarboxylic acid, the pH of the binder composition may require adjustment to achieve alkalinity.

An uncured, formaldehyde-free, thermally curable, alkaline, aqueous binder composition can be used to manufacture a number of different materials. Any number of well-known techniques can be employed to place the aqueous binder in contact with the material to be bound. For example, the aqueous binder can be sprayed on or applied via a roll-coat apparatus. Once the aqueous binder is in contact with the glass fibers, the residual heat from the glass fibers (note that the glass fibers are made from molten glass and thus contain residual heat) and the flow of air through the fibrous mat will evaporate (i.e., remove) water from the binder. Removing the water leaves the remaining components of the binder on the fibers as a coating of viscous or semi-viscous high-solids liquid. At this point, the mat has not been cured.

It should be appreciated that materials including a collection of glass fibers bonded with the cured binders used in the present invention may have a density in the range from about 0.4 lbs/ft³ to about 6 lbs/ft³. It should also be appreciated that such materials may have an R-value in the range from about 2 to about 60. Further, it should be appreciated that such materials may have a noise reduction coefficient in the range from about 0.45 to about 1.10.

In another illustrative embodiment, the cured binders described herein can be used in the present invention as glass fiber binders in a cured fiberglass insulation product exemplified by air duct board. Air duct board is a thermal and acoustical insulation product including glass fibers preformed into rigid, rectangular boards bonded with a thermoset binder. Air duct board is faced on the bottom with a foil-scrim-kraft (FSK) facing, and the air stream surface is faced with a lightweight black mat. The mat facing is intended to improve the abuse resistance of the airstream surface, lower the resistance to air flow, and improve the aesthetic appearance. Air duct board may be used in commercial and residential air handling installations, for cooling, heating, or dual-temperature service at operating temperatures ranging up to about 250° F., maximum air velocities of about 5000 fpm and about 2-in static pressure. Thermal resistance and acoustical properties for air duct board are determined in accordance with ASTM C518/ASTM C177 (at 75° F.) and ASTM E477, respectively. Thickness and/or density are determined in accordance with ASTM C 167. Air duct board typically requires a nominal fiber diameter of about 32±about 2 ht, nominal loss on ignition of about 15±about 2%, and application of a black overspray prior to thermal curing to adhere the non-woven mat to the board.

In one illustrative variation, air duct board has a nominal thickness of about 1 in, a flexural rigidity of about 475, an R-value of about 4.3, a density of about 4.5 lbs/ft³, a thermal conductivity of about 0.23 BTU in/hr ft² ° F., and a noise reduction coefficient of about 0.70. In another illustrative variation, air duct board has a nominal thickness of about 1.5 in, a flexural rigidity of about 800, an R-value of about 6.5, a density of about 3.8 lbs/ft³, a thermal conductivity of about 0.23 BTU in/hr ft² ° F., and a noise reduction coefficient of about 0.95, e.g., in such embodiments the density can be about 3.75 lbs/ft³. In another illustrative variation, air duct board has a nominal thickness of about 2 in, a flexural rigidity of about 800, an R-value of about 8.7, a density of about 3.8 lbs/ft³, and a thermal conductivity of about 0.23 BTU in/hr ft² ° F., e.g., in such embodiments the density can be about 3.75 lbs/ft³.

In another illustrative embodiment, the cured binders described herein can be used in the present invention as glass fiber binders in a cured fiberglass insulation product exemplified by air duct board (all glass mat). Air duct board (all glass mat) is a thermal and acoustical insulation product including glass fibers preformed into rigid, rectangular boards bonded with a thermoset binder. Air duct board (all glass mat) is faced on the bottom with a foil-scrim-kraft (FSK) facing, and the air stream surface is faced with a lightweight white glass mat. The mat facing is intended to improve the abuse resistance of the airstream surface, lower the resistance to air flow, and improve the aesthetic appearance. Air duct board (all glass mat) may be used in commercial and residential air handling installations, for cooling, heating, or dual-temperature service at operating temperatures ranging up to about 250° F., maximum air velocities of about 5000 fpm and about 2-in static pressure. Thermal resistance and acoustical properties for air duct board (all glass mat) are determined in accordance with ASTM C518/ASTM C177 (at 75° F.) and ASTM E477, respectively. Thickness and/or density are determined in accordance with ASTM C 167. Air duct board (all glass mat) typically requires a nominal fiber diameter of about 32±about 2 ht, nominal loss on ignition of about 15±about 2%, and application of a yellow overspray prior to thermal curing to adhere the non-woven mat to the board.

In one illustrative variation, air duct board (all glass mat) has a nominal thickness of about 1 in, a flexural rigidity of about 475, an R-value of about 4.3, a density of about 4.4 lbs/ft³, a thermal conductivity of about 0.23 BTU in/hr ft² ° F., and a noise reduction coefficient of about 0.70. In another variation, air duct board (all glass mat) has a nominal thickness of about 1.5 in, a flexural rigidity of about 800, an R-value of about 6.5, a density of about 4 lbs/ft³, a thermal conductivity of about 0.23 BTU in/hr ft²° F., and a noise reduction coefficient of about 0.95, e.g., in such embodiments the density can be about 3.75 lbs/ft³. In another variation, air duct board (all glass mat) has a nominal thickness of about 2 in, a flexural rigidity of about 800, an R-value of about 8.7, a density of about 4 lbs/ft³, a thermal conductivity of about 0.23 BTU in/hr ft² ° F., and a noise reduction coefficient of about 1.00, e.g., in such embodiments the density can be about 3.75 lbs/ft³.

In another illustrative embodiment, the cured binders described herein can be used in the present invention as glass fiber binders in a cured fiberglass insulation product exemplified by housing air duct board. Housing air duct board is a thermal insulation product including glass fibers preformed into rigid, rectangular boards bonded with a thermoset binder. Housing air duct board is faced on the bottom with a foil-scrim-kraft (FSK) facing, and the air stream surface is coated with an overspray prior to thermal curing to increase the abuse resistance of the airstream surface. Housing air duct board may be used in manufactured housing systems for dual-temperature service at operating temperatures ranging up to about 250° F., maximum air velocities of about 2400 fpm and about 2-in static pressure. Thermal properties for housing air duct board are determined in accordance with ASTM C518 and ASTM C177 (at 75° F.). Thickness and/or density are determined in accordance with ASTM C 167. Housing air duct board typically requires a nominal fiber diameter of about 35±about 2 ht, and a nominal loss on ignition of about 15±about 2%.

In one illustrative variation, housing air duct board has a nominal thickness of about 0.8 in, an R-value of about 3.5, a density of about 4.2 lbs/ft³, a square foot weight of about 0.3 lbs/ft², and a thermal conductivity of about 0.23 BTU in/hr ft² ° F., e.g., in such embodiments the square foot weight can be about 0.2846 lbs/ft². In another variation, housing air duct board has a nominal thickness of about 1 in, an R-value of about 4.0, a density of about 4.2 lbs/ft³, a square foot weight of about 0.3 lbs/ft², and a thermal conductivity of about 0.23 BTU in/hr ft² ° F., e.g., in such embodiments the square foot weight can be about 0.3281 lbs/ft².

In another illustrative embodiment, the cured binders described herein can be used in the present invention as glass fiber binders in a cured fiberglass insulation product exemplified by duct liner. Duct liner is a flexible edge-coated, mat-faced, thermal and acoustical insulation product including glass fibers bonded with a thermoset binder. Duct liner is faced with a non-woven black mat, providing the air stream side with a smooth, abuse resistant surface during installation and operation. The side edges are coated to reduce the need for “buttering” of transverse joints during fabrication. Duct liner may be used as an interior insulation material for sheet metal ducts in heating, ventilating, and air conditioning applications. It offers a combination of sound absorption, low thermal conductivity, and minimal air surface friction characteristics for systems operating at temperatures up to about 250° F. and velocities up to about 6000 fpm. Thermal resistance and acoustical properties for duct liner are determined in accordance with ASTM C518/ASTM C177 as per ASTM C653 (at 75° F.) and ASTM C423, respectively. Thickness and/or density are determined in accordance with ASTM C 167. Duct liner typically requires a nominal fiber diameter of about 22±about 2 ht, and nominal loss on ignition of about 17±about 2%.

In one illustrative variation, duct liner has a nominal thickness of about 1 in, a nominal density of about 1.5 lbs/ft³, an R-value of about 4.2, a thermal conductivity of about 0.24 BTU in/hr ft² ° F., and a noise reduction coefficient of about 0.70. In another variation, duct liner has a nominal thickness of about 1.5 in, a nominal density of about 1.5 lbs/ft³, an R-value of about 6, a thermal conductivity of about 0.16 BTU in/hr ft² ° F., and a noise reduction coefficient of about 0.80. In another variation, duct liner has a nominal thickness of about 2 in, a nominal density of about 1.5 lbs/ft³, an R-value of about 8, a thermal conductivity of about 0.13 BTU in/hr ft² ° F., and a noise reduction coefficient of about 0.90. In another variation, duct liner has a nominal thickness of about 0.5 in, a nominal density of about 2 lbs/ft³, an R-value of about 2.1, a thermal conductivity of about 0.48 BTU in/hr ft² ° F., and a noise reduction coefficient of about 0.45. In another variation, duct liner has a nominal thickness of about 1 in, a nominal density of about 2 lbs/ft³, an R-value of about 4.2, a thermal conductivity of about 0.24 BTU in/hr ft² ° F., and a noise reduction coefficient of about 0.70. In another variation, duct liner has a nominal thickness of about 1.5 in, a nominal density of about 2 lbs/ft³, an R-value of about 6.3, a thermal conductivity of about 0.16 BTU in/hr ft² ° F., and a noise reduction coefficient of about 0.85.

In another illustrative embodiment, the cured binders described herein can be used in the present invention as glass fiber binders in a cured fiberglass insulation product exemplified by equipment liner. Equipment liner is a flexible mat-faced, thermal and acoustical insulation product including glass fibers bonded with a thermoset binder. Equipment liner is faced with a non-woven black mat, providing the air stream side with a smooth, abuse resistant surface during installation and operation. Equipment liner may be used for OEM applications in heating, ventilating, and air conditioning applications. It offers a combination of sound absorption, low thermal conductivity, and minimal air surface friction characteristics for systems operating at temperatures up to about 250° F. and velocities up to about 6000 fpm. Thermal resistance and acoustical properties for equipment liner are determined in accordance with ASTM C177 (at 75° F.) and ASTM C423 (Mounting A), respectively. Thickness and/or density are determined in accordance with ASTM C 167. Equipment liner typically requires a nominal fiber diameter of about 22±about 2 ht, and nominal loss on ignition of about 17±about 2%.

In one illustrative variation, equipment liner has a nominal thickness of about 0.5 in, a nominal density of about 1.5 lbs/ft³, a thermal conductivity of about 0.25 BTU in/hr ft² ° F., and a noise reduction coefficient of about 0.45. In another variation, equipment liner has a nominal thickness of about 1 in, a nominal density of about 1.5 lbs/ft³, a thermal conductivity of about 0.25 BTU in/hr ft² ° F., and a noise reduction coefficient of about 0.70. In another variation, equipment liner has a nominal thickness of about 1.5 in, a nominal density of about 1.5 lbs/ft³, a thermal conductivity of about 0.25 BTU in/hr ft² ° F., and a noise reduction coefficient of about 0.80. In another variation, equipment liner has a nominal thickness of about 2 in, a nominal density of about 1.5 lbs/ft³, a thermal conductivity of about 0.25 BTU in/hr ft² ° F., and a noise reduction coefficient of about 0.90. In another variation, equipment liner has a nominal thickness of about 0.5 in, a nominal density of about 2 lbs/ft³, a thermal conductivity of about 0.24 BTU in/hr ft² ° F., and a noise reduction coefficient of about 0.45. In another variation, equipment liner has a nominal thickness of about 1 in, a nominal density of about 2 lbs/ft³, a thermal conductivity of about 0.24 BTU in/hr ft² ° F., and a noise reduction coefficient of about 0.70. In another variation, equipment liner has a nominal thickness of about 1.5 in, a nominal density of about 2 lbs/ft³, a thermal conductivity of about 0.24 BTU in/hr ft² ° F., and a noise reduction coefficient of about 0.85.

In another illustrative embodiment, the cured binders described herein can be used as glass fiber binders in a cured fiberglass insulation product exemplified by textile duct liner insulation. Textile duct liner insulation is a flexible edge-coated, mat-faced insulation including glass fibers bonded with a thermoset binder. This product is faced with a tightly bonded mat, providing the air stream side with a smooth, tough surface that resists damage during installation and operation. Textile duct liner may be used as an interior insulation material for sheet metal ducts in heating, ventilating, and air conditioning applications. It offers a combination of sound absorption, low thermal conductivity, and minimal air surface friction for systems operating at temperatures up to about 250° F. and velocities up to about 6000 fpm. Thermal and acoustical properties for textile duct liner are determined in accordance with ASTM C 177 and C423 (Type A Mounting), respectively. Thickness and/or density are determined in accordance with ASTM C 167.

In one illustrative variation, textile duct liner has a nominal density of about 1.5 lbs/ft³, a nominal thickness of about 1 in, a thermal conductance of about 0.25, a thermal resistance of about 4.0, and a noise reduction coefficient of about 0.70. In another variation, textile duct liner has a nominal density of about 1.5 lbs/ft³, a nominal thickness of about 1.5 in, a thermal conductance of about 0.17, a thermal resistance of about 6.0, and a noise reduction coefficient of about 0.80. In another variation, textile duct liner has a nominal density of about 1.5 lbs/ft³, a nominal thickness of about 2 in, a thermal conductance of about 0.13, a thermal resistance of about 8.0, and a noise reduction coefficient of about 0.90.

In another illustrative variation, textile duct liner has a nominal density of about 2 lbs/ft³, a nominal thickness of about 0.5 in, a thermal conductance of about 0.48, a thermal resistance of about 2.1, and a noise reduction coefficient of about 0.45. In another variation, textile duct liner has a nominal density of about 2 lbs/ft³, a nominal thickness of about 1 in, a thermal conductance of about 0.24, a thermal resistance of about 4.2, and a noise reduction coefficient of about 0.70. In another variation, textile duct liner has a nominal density of about 2 lbs/ft³, a nominal thickness of about 1.5 in, a thermal conductance of about 0.16, a thermal resistance of about 6.3, and a noise reduction coefficient of about 0.85.

In another illustrative embodiment, the cured binders described herein can be used in the present invention as glass fiber binders in a cured fiberglass insulation product exemplified by duct wrap insulation. Duct wrap insulation is a uniformly textured, resilient, thermal insulating and sound absorbing material including glass fibers that are bonded with a thermoset binder. Duct wrap insulation may be used to externally insulate air handling ducts for energy conservation and condensation control. Duct wrap insulation may or may not have a facing. If faced, facings may be foil-scrim-kraft (FSK), white or black poly-scrim-kraft (PSK), or white or grey vinyl. Duct wrap insulation may be used as external insulation on commercial or residential heating or air conditioning ducts with an operating temperature of about 45° F. to about 250° F. for faced products, and on commercial or residential heating ducts with a maximum operating temperature of about 350° F. for unfaced products. Thermal resistance properties for duct wrap insulation are determined in accordance with ASTM C177 (at 75° F.) and ASTM C518. Thickness and/or density are determined in accordance with ASTM C 167. Faced duct wrap insulation typically requires a nominal fiber diameter of about 18±about 2 ht; unfaced duct wrap typically requires a nominal fiber diameter of about 20±about 2 ht (nominal loss on ignition for both is about 7±about 1%).

Illustratively, duct wrap insulation at a nominal density of about 0.75 lbs/ft³ displays thermal conductivity (in BTU in/hr ft² ° F.) as a function of mean temperature as follows: 50° F., 0.28; 75° F., 0.29; 100° F., 0.31; 125° F., 0.33; 150° F., 0.36; 175° F., 0.39; and 200° F., 0.43. Illustratively, duct wrap insulation at a nominal density of about 1 lbs/ft³ displays thermal conductivity (in BTU in/hr ft² ° F.) as a function of mean temperature as follows: 50° F., 0.26; 75° F., 0.27; 100° F., 0.29; 125° F., 0.31; 150° F., 0.34; 175° F., 0.37; and 200° F., 0.40. Illustratively, duct wrap insulation at a nominal density of about 1.5 lbs/ft³ displays thermal conductivity (in BTU in/hr ft² ° F.) as a function of mean temperature as follows: 50° F., 0.23; 75° F., 0.24; 100° F., 0.26; 125° F., 0.28; 150° F., 0.31; 175° F., 0.33; and 200° F., 0.36.

In one illustrative variation, duct wrap has a nominal thickness of about 1 in, a nominal density of about 0.75 lbs/ft³, an out-of-package R-value of about 3.4, and an installed R-value (at 25% compression) of about 2.8. In another variation, duct wrap has a nominal thickness of about 1.5 in, a nominal density of about 0.75 lbs/ft³, an out-of-package R-value of about 5.1, and an installed R-value (at 25% compression) of about 4.2. In another variation, duct wrap has a nominal thickness of about 2 in, a nominal density of about 0.75 lbs/ft³, an out-of-package R-value of about 6.8, and an installed R-value (at 25% compression) of about 5.6. In another variation, duct wrap has a nominal thickness of about 2.2 in, a nominal density of about 0.75 lbs/ft³, an out-of-package R-value of about 7.4, and an installed R-value (at 25% compression) of about 6. In another variation, duct wrap has a nominal thickness of about 2.5 in, a nominal density of about 0.75 lbs/ft³, an out-of-package R-value of about 8.5, and an installed R-value (at 25% compression) of about 7. In another variation, duct wrap has a nominal thickness of about 3 in, a nominal density of about 0.75 lbs/ft³, an out-of-package R-value of about 10.2, and an installed R-value (at 25% compression) of about 8.4.

In another variation, duct wrap has a nominal thickness of about 1 in, a nominal density of about 1 lbs/ft³, an out-of-package R-value of about 3.7, and an installed R-value (at 25% compression) of about 3. In another variation, duct wrap has a nominal thickness of about 1.5 in, a nominal density of about 1 lbs/ft³, an out-of-package R-value of about 5.6, and an installed R-value (at 25% compression) of about 4.5. In another variation, duct wrap has a nominal thickness of about 2 in, a nominal density of about 1 lbs/ft³, an out-of-package R-value of about 7.4, and an installed R-value (at 25% compression) of about 6.

In another variation, duct wrap has a nominal thickness of about 1 in, a nominal density of about 1.5 lbs/ft³, an out-of-package R-value of about 4.1, and an installed R-value (at 25% compression) of about 3.2. In another variation, duct wrap has a nominal thickness of about 1.5 in, a nominal density of about 1.5 lbs/ft³, an out-of-package R-value of about 6.1, and an installed R-value (at 25% compression) of about 4.8. In another variation, duct wrap has a nominal thickness of about 2 in, a nominal density of about 1.5 lbs/ft³, an out-of-package R-value of about 8.2, and an installed R-value (at 25% compression) of about 6.4.

In another illustrative embodiment, the cured binders described herein can be used in the present invention as glass fiber binders in a cured fiberglass insulation product exemplified by pipe insulation. Pipe insulation is a slit, one-piece, hollow cylindrical-molded, heavy-density insulation including glass fibers that are bonded with a thermoset binder typically produced in about 3-in lengths with or without a factory-applied jacket. The jacket is a white-kraft paper bonded to aluminum foil and reinforced with glass fibers, and the longitudinal flap of the jacket is available with or without a self-sealing adhesive. Pipe insulation may be used in power, process, and industrial applications and commercial and institutional buildings where fire safety, resistance to physical abuse, and a finished building appearance is desired. This product is intended for use on systems with operating temperatures from about 0° F. to about 1000° F. Thermal conductivity for pipe insulation-1000° F. is determined in accordance with ASTM C 335.

Illustratively, pipe insulation displays thermal conductivity (in BTU in/hr ft² ° F.) as a function of mean temperature as follows: 75° F., 0.23; 100° F., 0.24; 200° F., 0.28; 300° F., 0.34; 400° F., 0.42; 500° F., 0.51; and 600° F., 0.62.

With respect to making binders that are water-resistant thermoset binders when cured, it should be appreciated that the ratio of the number of molar equivalents of acid salt groups present on the polycarboxylic acid reactant to the number of molar equivalents of hydroxyl groups present on the carbohydrate reactant may be in the range from about 0.04:1 to about 0.15:1. After curing, these formulations result in a water-resistant thermoset binder. In one illustrative variation, the number of molar equivalents of hydroxyl groups present on the carbohydrate reactant is about twenty-five-fold greater than the number of molar equivalents of acid salt groups present on the polycarboxylic acid reactant. In another variation, the number of molar equivalents of hydroxyl groups present on the carbohydrate reactant is about ten-fold greater than the number of molar equivalents of acid salt groups present on the polycarboxylic acid reactant. In yet another variation, the number of molar equivalents of hydroxyl groups present on the carbohydrate reactant is about six-fold greater than the number of molar equivalents of acid salt groups present on the polycarboxylic acid reactant.

In other illustrative embodiments of the present invention, a binder that is already cured can be disposed on a material to be bound. As indicated above, most cured binders of the present invention will typically contain water-insoluble melanoidins. Accordingly, these binders will also be water-resistant thermoset binders.

As discussed below, various additives can be incorporated into the binder composition. These additives may give the binders used in the present invention additional desirable characteristics. For example, the binder may include a silicon-containing coupling agent. Many silicon-containing coupling agents are commercially available from the Dow-Corning Corporation, Petrarch Systems, and from the General Electric Company. Illustratively, the silicon-containing coupling agent includes compounds such as silylethers and alkylsilyl ethers, each of which may be optionally substituted, such as with halogen, alkoxy, amino, and the like. In one variation, the silicon-containing compound is an amino-substituted silane, such as, gamma-aminopropyltriethoxy silane (General Electric Silicones, SILQUEST A-1101; Wilton, CT; USA). In another variation, the silicon-containing compound is an amino-substituted silane, for example, aminoethylaminopropyltrimethoxy silane (Dow Z-6020; Dow Chemical, Midland, MI; USA). In another variation, the silicon-containing compound is gamma-glycidoxypropyltrimethoxysilane (General Electric Silicones, SILQUEST A-187). In yet another variation, the silicon-containing compound is an n-propylamine silane (Creanova (formerly Huls America) HYDROSIL 2627; Creanova; Somerset, N.J.; U.S.A.).

The silicon-containing coupling agents are typically present in the binder in the range from about 0.1 percent to about 1 percent by weight based upon the dissolved binder solids (i.e., about 0.1 percent to about 1 percent based upon the weight of the solids added to the aqueous solution). In one application, one or more of these silicon-containing compounds can be added to the aqueous uncured binder. The binder is then applied to the material to be bound. Thereafter, the binder may be cured. These silicon-containing compounds enhance the ability of the binder to adhere to the matter the binder is disposed on, such as glass fibers. Enhancing the binder's ability to adhere to the matter improves, for example, its ability to produce or promote cohesion in non-assembled or loosely assembled substances.

A binder that includes a silicon-containing coupling agent can be prepared from a polycarboxylic acid reactant and a carbohydrate reactant, the latter having reducing sugar, which reactants are added as solids, mixed into and dissolved in water, and then treated with aqueous amine base (to neutralize the polycarboxylic acid reactant) and a silicon-containing coupling agent to generate an aqueous solution about 3-50 weight percent in each of a polycarboxylic acid reactant and a carbohydrate reactant. In one illustrative variation, a binder that includes a silicon-containing coupling agent can be prepared by admixing about 3 weight percent to about 50 weight percent aqueous solution of a polycarboxylic acid reactant, already neutralized with an amine base or neutralized in situ, with about 3-50 weight percent aqueous solution of a carbohydrate reactant having reducing sugar, and an effective amount of a silicon-containing coupling agent.

In another illustrative embodiment, a binder used in the present invention may include one or more corrosion inhibitors. These corrosion inhibitors may prevent or inhibit the eating or wearing away of a substance, such as metal, caused by chemical decomposition brought about by an acid. When a corrosion inhibitor is included in a binder used in the present invention, the binder's corrosivity is decreased as compared to the corrosivity of the binder without the inhibitor present. In another embodiment, these corrosion inhibitors can be utilized to decrease the corrosivity of the glass fiber-containing compositions described herein. Illustratively, corrosion inhibitors may include one or more of the following, a dedusting oil, a monoammonium phosphate, sodium metasilicate pentahydrate, melamine, tin(II)oxalate, and/or methylhydrogen silicone fluid emulsion. When included in a binder of the present invention, corrosion inhibitors are typically present in the binder in the range from about 0.5 percent to about 2 percent by weight based upon the dissolved binder solids.

By following the disclosed guidelines, one of ordinary skill in the art will be able to vary the concentrations of the reactants of the aqueous binder to produce a wide range of binder compositions. In particular, aqueous binder compositions can be formulated to have an alkaline pH. For example, a pH in the range from greater than or equal to about 7 to less than or equal to about 10. Examples of the binder reactants that can be manipulated, i.e., varied, include (i) the polycarboxylic acid, (ii) the amine reactant, (iii) the carbohydrate reactant, (iv) the non-carbohydrate polyhydroxy reactant, (v) the silicon-containing coupling agent, and (vi) the corrosion inhibitor compounds. Having the pH of the aqueous binders (e.g., uncured binders) of the present invention in the alkaline range inhibits the corrosion of materials the binder comes in contact with, such as machines used in the manufacturing process (e.g., in manufacturing fiberglass). It is worth noting that this is especially true when the corrosivity of acidic binders is compared to binders used in the present invention. Accordingly, the “life span” of the machinery increases while the cost of maintaining these machines decreases. Furthermore, standard equipment can be utilized with the binders used in the present invention, rather than having to utilize relatively corrosive resistant machine components that come into contact with acidic binders, such as stainless-steel components. Therefore, the binders disclosed herein for use in the present invention decrease the cost of manufacturing bound materials.

The following examples illustrate specific embodiments in further detail. These examples are provided for illustrative purposes only and should not be construed as limiting the present invention or the inventive concept to any particular physical configuration in any way. For instance, separate aqueous solutions of the polycarboxylic acid ammonium salt reactant and the reducing-sugar carbohydrate reactant the weight percents of each of which fall within the range from about 3-50 weight percent can be admixed to prepare the binders used in the present invention. Further, aqueous solutions including the polycarboxylic acid ammonium salt reactant and the reducing-sugar carbohydrate reactant the weight percents of each of which fall outside the range of about 3-50 weight percent can be used to prepare the binders used in the present invention. In addition, a primary amine salt or a secondary amine salt of a polycarboxylic acid may be used as the polycarboxylic acid ammonium salt reactant to prepare the binders used in the present invention.

### Example 1

### Preparation of Aqueous Triammonium Citrate-Dextrose Binders

Aqueous triammonium citrate-dextrose binders were prepared according to the following procedure: Aqueous solutions (25%) of triammonium citrate (81.9 g citric acid, 203.7 g water, and 114.4 g of a 19% percent solution of ammonia) and dextrose monohydrate (50.0 g of dextrose monohydrate in 150.0 g water) were combined at room temperature in the following proportions by volume: 1:24, 1:12, 1:8, 1:6, 1:5, 1:4, and 1:3, where the relative volume of triammonium citrate is listed as “1.” For example, 10 mL of aqueous triammonium citrate mixed with 40 mL of aqueous dextrose monohydrate afforded a “1:4” solution, wherein the mass ratio of triammonium citrate to dextrose monohydrate is about 1:4, the molar ratio of triammonium citrate to dextrose monohydrate is about 1:5, and the ratio of the number of molar equivalents of acid salt groups, present on triammonium citrate, to the number of molar equivalents of hydroxyl groups, present on dextrose monohydrate, is about 0.12:1. The resulting solutions were stirred at room temperature for several minutes, at which time 2-g samples were removed and thermally cured as described in Example 2.

### Example 2

### Preparation of Cured Triammonium Citrate-Dextrose Binder Samples from Aqueous Triammonium Citrate-Dextrose Binders

2-g samples of each binder, as prepared in Example 1, were placed onto each of three individual 1-g aluminum bake-out pans. Each binder was then subjected to the following three conventional bake-out/cure conditions in pre-heated, thermostatted convection ovens in order to produce the corresponding cured binder sample: 15 minutes at 400° F., 30 minutes at 350° F., and 30 minutes at 300° F.

### Example 3

### Testing/Evaluation of Cured Triammonium Citrate-Dextrose Binder Samples Produced from Aqueous Triammonium Citrate-Dextrose Binders

Wet strength was determined for each cured triammonium citrate-dextrose binder sample, as prepared in Example 2, by the extent to which a cured binder sample appeared to remain intact and resist dissolution, following addition of water to the aluminum bake-out pan and subsequent standing at room temperature. Wet strength was noted as Dissolved (for no wet strength), Partially Dissolved (for minimal wet strength), Softened (for intermediate wet strength), or Impervious (for high wet strength, water-insoluble). The color of the water resulting from its contact with cured triammonium citrate-dextrose binder samples was also determined. Table 1 below shows illustrative examples of triammonium citrate-dextrose binders prepared according to Example 1, curing conditions therefor according to Example 2, and testing and evaluation results according to Example 3.

### Example 4

### Preparation of Ammonium Polycarboxylate-Sugar Binders Used to Construct Glass Bead Shell Bones

Aqueous triammonium citrate-dextrose (1:6) binders, which binders were used to construct glass bead shell bones, were prepared by the following general procedure: Powdered dextrose monohydrate (915 g) and powdered anhydrous citric acid (152.5 g) were combined in a 1-gallon reaction vessel to which 880 g of distilled water was added. To this mixture were added 265 g of 19% aqueous ammonia with agitation, and agitation was continued for several minutes to achieve complete dissolution of solids. To the resulting solution were added 3.3 g of SILQUEST A-1101 silane to produce a pH ˜8-9 solution (using pH paper), which solution contained approximately 50% dissolved dextrose monohydrate and dissolved ammonium citrate solids (as a percentage of total weight of solution); a 2-g sample of this solution, upon thermal curing at 400° F. for 30 minutes, would yield 30% solids (the weight loss being attributed to dehydration during thermoset binder formation). Where a silane other than SILQUEST A-1101 was included in the triammonium citrate-dextrose (1:6) binder, substitutions were made with SILQUEST A-187 Silane, HYDROSIL 2627 Silane, or Z-6020 Silane. When additives were included in the triammonium citrate-dextrose (1:6) binder to produce binder variants, the standard solution was distributed among bottles in 300-g aliquots to which individual additives were then supplied.

When polycarboxylic acids other than citric acid, sugars other than dextrose, and/or additives were used to prepare aqueous ammonium polycarboxylate-sugar binder variants, the same general procedure was used as that described above for preparation of an aqueous triammonium citrate-dextrose (1:6) binder. For ammonium polycarboxylate-sugar binder variants, adjustments were made as necessary to accommodate the inclusion of, for example, a dicarboxylic acid or a polymeric polycarboxylic acid instead of citric acid, or to accommodate the inclusion of, for example, a triose instead of dextrose, or to accommodate the inclusion of, for example, one or more additives. Such adjustments included, for example, adjusting the volume of aqueous ammonia necessary to generate the ammonium salt, adjusting the gram amounts of reactants necessary to achieve a desired molar ratio of ammonium polycarboxylate to sugar, and/or including an additive in a desired weight percent.

### Example 5

### Preparation/Weathering/Testing of Glass Bead Shell Bone Compositions Prepared with Ammonium Polycarboxylate-Sugar Binders

When evaluated for their dry and “weathered” tensile strength, glass bead-containing shell bone compositions prepared with a given binder provide an indication of the likely tensile strength and the likely durability, respectively, of fiberglass insulation prepared with that particular binder. Predicted durability is based on a shell bone's weathered tensile strength:dry tensile strength ratio. Shell bones were prepared, weathered, and tested as follows:

### Preparation Procedure for Shell Bones:

A shell bone mold (Dietert Foundry Testing Equipment; Heated Shell Curing Accessory, Model 366, and Shell Mold Accessory) was set to a desired temperature, generally 425° F., and allowed to heat up for at least one hour. While the shell bone mold was heating, approximately 100 g of an aqueous ammonium polycarboxylate-sugar binder (generally 30% in binder solids) was prepared as described in Example 5. Using a large glass beaker, 727.5 g of glass beads (Quality Ballotini Impact Beads, Spec. AD, US Sieve 70-140, 106-212 micron-#7, from Potters Industries, Inc.) were weighed by difference. The glass beads were poured into a clean and dry mixing bowl, which bowl was mounted onto an electric mixer stand. Approximately 75 g of aqueous ammonium polycarboxylate-sugar binder were obtained, and the binder then poured slowly into the glass beads in the mixing bowl. The electric mixer was then turned on and the glass beads/ammonium polycarboxylate-sugar binder mixture was agitated for one minute. Using a large spatula, the sides of the whisk (mixer) were scraped to remove any clumps of binder, while also scraping the edges wherein the glass beads lay in the bottom of the bowl. The mixer was then turned back on for an additional minute, and then the whisk (mixer) was removed from the unit, followed by removal of the mixing bowl containing the glass beads/ammonium polycarboxylate-sugar binder mixture. Using a large spatula, as much of the binder and glass beads attached to the whisk (mixer) as possible were removed and then stirred into the glass beads/ammonium polycarboxylate-sugar binder mixture in the mixing bowl. The sides of the bowl were then scraped to mix in any excess binder that might have accumulated on the sides. At this point, the glass beads/ammonium polycarboxylate-sugar binder mixture was ready for molding in a shell bone mold.

The slides of the shell bone mold were confirmed to be aligned within the bottom mold platen. Using a large spatula, a glass beads/ammonium polycarboxylate-sugar binder mixture was then quickly added into the three mold cavities within the shell bone mold. The surface of the mixture in each cavity was flattened out, while scraping off the excess mixture to give a uniform surface area to the shell bone. Any inconsistencies or gaps that existed in any of the cavities were filled in with additional glass beads/ammonium polycarboxylate-sugar binder mixture and then flattened out. Once a glass beads/ammonium polycarboxylate-sugar binder mixture was placed into the shell bone cavities, and the mixture was exposed to heat, curing began. As manipulation time can affect test results, e.g., shell bones with two differentially cured layers can be produced, shell bones were prepared consistently and rapidly. With the shell bone mold filled, the top platen was quickly placed onto the bottom platen. At the same time, or quickly thereafter, measurement of curing time was initiated by means of a stopwatch, during which curing the temperature of the bottom platen ranged from about 400° F. to about 430° F., while the temperature of the top platen ranged from about 440° F. to about 470° F. At seven minutes elapsed time, the top platen was removed and the slides pulled out so that all three shell bones could be removed. The freshly made shell bones were then placed on a wire rack, adjacent to the shell bone mold platen, and allowed to cool to room temperature. Thereafter, each shell bone was labeled and placed individually in a plastic storage bag labeled appropriately. If shell bones could not be tested on the day they were prepared, the shell bone-containing plastic bags were placed in a desiccator unit.

### Conditioning (Weathering) Procedure for Shell Bones:

A Blue M humidity chamber was turned on and then set to provide weathering conditions of 90° F. and 90% relative humidity (i.e., 90° F./90% rH). The water tank on the side of the humidity chamber was checked and filled regularly, usually each time it was turned on. The humidity chamber was allowed to reach the specified weathering conditions over a period of at least 4 hours, with a day-long equilibration period being typical. Shell bones to be weathered were loaded quickly (since while the doors are open both the humidity and the temperature decrease), one at a time through the open humidity chamber doors, onto the upper, slotted shelf of the humidity chamber. The time that the shell bones were placed in the humidity chamber was noted, and weathering conducted for a period of 24 hours. Thereafter, the humidity chamber doors were opened and one set of shell bones at a time were quickly removed and placed individually into respective plastic storage bags, being sealed completely. Generally, one to four sets of shell bones at a time were weathered as described above. Weathered shell bones were immediately taken to the Instron room and tested.

### Test Procedure for Breaking Shell Bones:

In the Instron room, the shell bone test method was loaded on the 5500 R Instron machine while ensuring that the proper load cell was installed (i.e., Static Load Cell 5 kN), and the machine allowed to warm up for fifteen minutes. During this period of time, shell bone testing grips were verified as being installed on the machine. The load cell was zeroed and balanced, and then one set of shell bones was tested at a time as follows: A shell bone was removed from its plastic storage bag and then weighed. The weight (in grams) was then entered into the computer associated with the Instron machine. The measured thickness of the shell bone (in inches) was then entered, as specimen thickness, three times into the computer associated with the Instron machine. A shell bone specimen was then placed into the grips on the Instron machine, and testing initiated via the keypad on the Instron machine. After removing a shell bone specimen, the measured breaking point was entered into the computer associated with the Instron machine, and testing continued until all shell bones in a set were tested.

Test results are shown in Table 2 and Table 3, which results are mean dry tensile strength (psi), mean weathered tensile strength (psi), and weathered:dry tensile strength ratio.

### Example 6

### Blade Wear Analysis—Cutability Results as a Function of Binder Type on Air Duct Board

### Manufacturing Air Duct Board as a Function of Binder Type

Air duct board was prepared using conventional fiberglass manufacturing procedures; such procedures are described generally in U.S. Pat. No. 5,318,990, the disclosure of which is hereby incorporated herein by reference. Binders used in the preparation of air duct board were designated:
SP1=Phenol-Formaldehyde (PF)
SP2=Triammonium Citrate/High Fructose Corn Syrup (HFCS-42)
SP3=Diammonium Phosphate/High Fructose Corn Syrup (HFCS-42)
   and were prepared according to the recipes shown below using conventional binder preparation procedures described generally in U.S. Pat. No. 5,300,652, WO 2007/014236, and WO2009/019235, respectively, the disclosures of which are hereby incorporated herein by reference.
   (Note: HFCS-42 refers to the dry weight fructose composition of 42% in High Fructose Corn Syrup, with the rest, i.e., 58%, being dextrose.)

| | Ingredient | % Solids | Dry Ratio | Final Formula (lb) |
|---|---|---|---|---|
| SP1 | Water | 0 | 0.00 | 5113.8 |
| | PF-Urea Premix | 47 | 93.81 | 4450.4 |
| | Ammonium Sulfate | 40 | 4.40 | 245.6 |
| | Aqueous Ammonia | 19 | 1.57 | 185.2 |
| | Silane | 100 | 0.23 | 5.0 |
| SP2 | Water | 0 | 0.00 | 4579.2 |
| | HFCS-42 | 71 | 78.16 | 3512.9 |
| | Citric Acid | 50 | 16.58 | 1061.1 |
| | Ammonia | 19 | 4.97 | 837.7 |
| | Silane | 100 | 0.28 | 9.1 |
| SP3 | Water | 0 | 0.00 | 5137.0 |
| | HFCS-42 | 71 | 92.90 | 4175.2 |
| | Diammonium Phosphate | 32 | 6.77 | 677.3 |
| | Silane | 100 | 0.33 | 10.5 |

Air duct board prepared with SP1 binder existed the oven off-white in color, whereas air duct board prepared with SP2 and SP3 binders exited the oven brown in color (consistent with formation and presence of brown-colored nitrogenous polymeric and co-polymeric melanoidins). Each of the three air duct board products appeared well bonded. Physical properties of the resulting air duct boards, which are shown in Table 4, confirm that comparable products were made.

### Blade Wear Analysis—Test Setup

Testing for blade wear was conducted by assessing cutability of air duct boards prepared with SP1, SP2 and SP3 binders as follows:
Use a Zenbot CNC to automatically make cuts in air duct boards
Use a single, new GlassMaster® blade to cut channels in each air duct board
Make 19 cuts per board, spaced 2 inches from each other that measure 38.5 inches across in each board; therefore, 62.5 linear feet cut per board
Categorize the cuts visually into 4 categories: 1=Good, 2=Minimal, 3=Significant, 4=Severe (where ease of strip removal also factored into category)
Inspect each cut air duct board for “fuzz” or stray fiber in the channels with an eye for clean, crisp channels
   Upon inspection of each cut air duct board, a “cutability rating” was assigned, which refers to the cleanness or smoothness of the cuts made in each board and is represented by the numerical average of numbers assigned to individual cuts on each board ranging from 1 to 4, where 1=Good, 2=Minimal, 3=Significant, and 4=Severe. For example, a cutability rating of 1 or “Good” describes an air duct board with completely smooth cuts, i.e., where minimal fuzz or stray fiber is present within clean, crisp channels cut into the air duct board. A “Severe” rating of 4 denotes a very ragged edge that is aesthetically objectionable.

### Blade Wear Analysis—Cutability Results

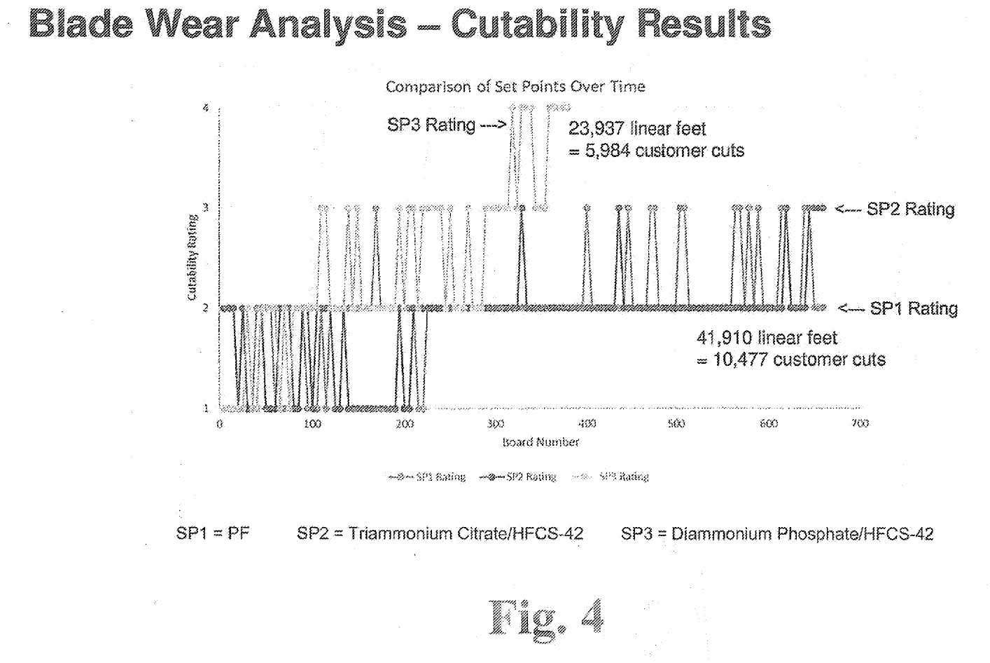

Cutability as a function of binder type on air duct board is shown in FIG. 4. Whereas air duct board manufactured either with a binder (SP2) used in the present invention, which is based, inter alia, on a combination of a carbohydrate and, for example, an ammonium salt of one or more polycarboxylic acids, or with a phenol-formaldehyde (PF) binder (SP1) maintains a cutability rating of about 1 to about 2 over at least about 40,000 linear cut feet, air duct board manufactured with a binder based on a combination of a carbohydrate and an ammonium salt of an inorganic acid (SP3) has a cutability rating approaching 3 after only about 12,000 linear cut feet, which increases to a cutability rating of 4 after about 22,000 linear cut feet.

Thus, binders used in the present invention unexpectedly impart cutability (properties) to thermal and/or acoustical insulation products that is not only comparable to the cutability (properties) exhibited by such products manufactured with phenol-formaldehyde (PF) binders, but also demonstrably improved compared to the cutability (properties) of such products manufactured with a binder embodied in an arguably similar binder system (described in WO 2009/019235). Since cutability is a proxy for assessing the integrity, i.e., sharpness vs. dullness, of cutting blades, the present invention also unexpectedly results in greater wearability, durability, and/or longevity of cutting blades used in fabrication of thermal and/or acoustical insulation.

TABLE 1
Testing/Evaluation Results for Cured Triammonium Citrate-Dextrose Binder Samples^{a}

| BINDER COMPOSITION | | | Wet | Water | Wet | Water | Wet | Water |
|---|---|---|---|---|---|---|---|---|
| Triammonium citrate ^{b}:Dextrose•H₂O ^{c} | | | Strength | Color | Strength | Color | Strength | Color |
| Mass Ratio | Mole Ratio^{d} | COOH:OH Ratio^{d} | (400° F.) | (400° F.) | (350° F.) | (350° F.) | (300° F.) | (300° F.) |
| 1:24 | (1:30) | 0.02:1 | Dissolved | Light | Dissolved | Light | Dissolved | Light |
| | | | | caramel- | | caramel- | | caramel- |
| | | | | colored | | colored | | colored |
| 1:12 | (1:15) | 0.04:1 | Impervious | Clear and | Dissolved | Caramel- | Dissolved | Caramel- |
| | | | | colorless | | colored | | colored |
| 1:8 | (1:10) | 0.06:1 | Impervious | Clear and | Partially | Caramel- | Dissolved | Caramel- |
| | | | | colorless | Dissolved | colored | | colored |
| 1:6 | (1:7) | 0.08:1 | Impervious | Clear and | Softened | Clear | Dissolved | Caramel- |
| | | | | colorless | | yellow | | colored |
| 1:5 | (1:6) | 0.10:1 | Impervious | Clear and | Softened | Clear | Dissolved | Caramel- |
| | | | | colorless | | yellow | | colored |
| 1:4^{e} | (1:5)^{e} | 0.12:1^{e} | Impervious | Clear and | Softened | Clear | Dissolved | Caramel- |
| | | | | colorless | | yellow | | colored |
| 1:3^{e} | (1:4)^{e} | 0.15:1^{e} | Impervious | Clear and | Softened | Clear | Dissolved | Caramel- |
| | | | | colorless | | orange | | colored |

^{a}From Examples 1-3
^{b} MW = 243 g/mol; 25% (weight percent) solution
^{c} MW = 198 g/mol; 25% (weight percent) solution
^{d}Approximate
^{e}Associated with distinct ammonia smell

TABLE 2
Measured Tensile Strength for Glass Bead Shell Bone Compositions^{a}
Prepared with Ammonium Polycarboxylate-Dextrose Binder Variants^{b}
vs. Polycarboxylic Acid-based Binders vs. Standard PF Binder

| | Weathered: | Mean^{c} | Mean |
|---|---|---|---|
| | Dry Tensile | Dry | Weathered |
| | Strenth | Tensile | Tensile |
| Binder Description | Ratio | Strength (psi) | Strength (psi) |
| Triammonium citrate-dextrose | 0.76^{d} | 358^{d} | 273^{d} |
| (1:6)^{d} | | | |
| Triammonium citrate-dextrose | 0.68 | 377 | 257 |
| (1:5) | | | |
| +Sodium carbonate (0.9 g) | 0.71 | 341 | 243 |
| +Sodium carbonate (1.8 g) | 0.78 | 313 | 243 |
| AQUASET-529 + Dex + | 0.41 | 499 | 205 |
| Ammonia^{e} | | | |
| AQUASET-529 + Dex + | 0.57 | 541 | 306 |
| Silane^{f} | | | |
| AQUASET-529 + Ammonia + | 0.11 | 314 | 33 |
| Silane^{g} | | | |
| AQUASET-529 + Saline^{h} | 0.48 | 605 | 293 |
| PETol + Maleic Acid + | 0.73 | 654 | 477 |
| Silaneⁱ | | | |
| PETol + Maleic Acid + TSA + | 0.64 | 614 | 390 |
| Silane^{j} | | | |
| [Binderⁱ + Ammonia + Dex + | 0.58 | 420 | 245 |
| Silane]^{k} | | | |
| PETol + Citric Acid + Silane^{l} | 0.56 | 539 | 303 |
| CRITERION 2000 + Glycerol^{m} | 0.26 | 532 | 136 |
| CRITERION 2000 + Glycerolⁿ | 0.20 | 472 | 95 |
| SOKALAN + Dex + Ammonia^{o} | 0.66 | 664 | 437 |
| NF1 + Dex + Ammonia^{p} | 0.50 | 877 | 443 |
| Standard PF (Ductliner) Binder | 0.79 | 637 | 505 |

^{a}From Example 5
^{b}From Example 4
^{c}Mean of nine shell bone samples
^{d}Average of seven different batches of triammonium citrate-dextrose (1:6) binder made over a five-month period
^{e}200 g AQUASET-529 + 87 g 19% ammonia + 301 g Dextrose + 301 g water to be a 30% solution
^{f}300 mL of solution from binder^{e} + 0.32 g of SILQUEST A-1101
^{g}200 g AQUASET-529 + 87 g 19% ammonia + 101 g water + 0.6 g SILQUEST A-1101
^{h}AQUASET-529 + SILQUEST A-1101 (at 0.5% binder solids), diluted to 30% solids
ⁱ136 g pentaerythritol + 98 g maleic anhydride + 130 g water, refluzed for 30 minutes; 232 g of resulting solution mixed with 170 g water and 0.6 g of SILQUEST A-1101
^{j}136 g pentaerythritol + 98 g maleic anhydride + 130 g water + 1.5 mL of 66% p-toluenesulfonic acid, refluxed for 30 minutes; 232 g of resulting solution mixed with 170 g water and 0.6 g of SILQUEST A-1101
^{k}220 g of binderⁱ + 39 g of 19% ammonia + 135 g Dextrose + 97 g water + 0.65 g SILQUEST A-1101
^{l}128 g of citric acid + 45 g of pentaeruthritol + 125 g of water, refluxed for 20 minutes; resulting mixture diluted to 30% solids and SILQUEST A-1101 added at 0.5% on solids
^{m}200 g of Kemira CRITERION 2000 + 23 g glycerol + 123 g water + 0.5 g SILQUEST A-1101
ⁿ200 g of Kemira CRITERION 2000 + 30 g glycerol + 164 g water + 0.6 g SILQUEST A-1101
^{o}100 g of BASF SOKALAN CP 10 S + 57 g 19% ammonia + 198 g Dextrose + 180 g water + 0.8 g SILQUEST A-1101
^{p}211 g of H.B. Fuller NF1 + 93 g 19% ammonia + 321 g Dextrose + 222 g water + 1.33 g SILQUEST A-1101

TABLE 3
Measured Tensile Strength for Glass Bead Shell Bone Compositions^{a} Prepared
with Ammonium Polycarboxylate-Sugar Binder Variants^{b} vs. Standard PF Binder

| | | | Mean^{c} | Meanc |
|---|---|---|---|---|
| | | Weathered: | Dry | Weathered |
| | | Dry Tensile | Tensile | Tensile |
| | Molar Ratio | Strength | Strength | Strength |
| Binder Description | (Amm. Salt:Sugar) | Ratio | (psi) | (psi) |
| Triammonium citrate-Dextrose^{d} | 1:6 | 0.76^{d} | 358^{d} | 273^{d} |
| Triammonium citrate-DHA^{e} | 1:6 | 1.02 | 130 | 132 |
| Triammonium citrate-Xylose | 1:6 | 0.75 | 322 | 241 |
| Triammonium citrate-Fructose | 1:6 | 0.79 | 363 | 286 |
| Diammonium tartarate-Dextrose | 1:4 | 0.76 | 314 | 239 |
| Diammonium maleate-Dextrose | 1:4 | 0.78 | 393 | 308 |
| Diammonium maliate-Dextrose | 1:4 | 0.67 | 49 | 280 |
| Diammonium succinate-Dextrose | 1:4 | 0.70 | 400 | 281 |
| Ammonium lactate^{f}-Dextrose | 1:2 | 0.68 | 257 | 175 |
| Ammonia + tannic acid^{g}-Dextrose | 1:50 ^{h} | 0.50 | 395 | 199 |
| Standard PF (Ductliner) Binder | — | 0.79 | 637 | 505 |

^{a}From Example 5
^{b}From Example 4
^{c}Mean of nine shell bone samples
^{d}Average of seven batches
^{e}DHA = dishydroxyacetone
^{f}Monocarboxylate
^{g}Non-carboxylic acid
^{h} pH ≥ 7

TABLE 4
Physical Property Testing of Air Duct Boards

| Test | SP1 | SP2 | SP3 |
|---|---|---|---|
| C411/C447-Hot Surface | Pass | Pass | Pass |
| C165-Compressive Resilience-10% | 24.68 | 47.05 | 47.55 |
| C165-Compressive Resilience-25% | 180.65 | 239.64 | 246.34 |
| C203-Flex (Avg. Max Load, lbf) | 8.48 | 8.57 | 7.85 |
| C203-Flex (Avg. Flex Yield | 12.61 | 20.25 | 13.96 |
| Strength, lbf) | | | |
| C203-Flex (Avg. Stress @ 0.5″ | 7.88 | 8.07 | 7.8 |
| Strain, psi) | | | |
| AHS 100-74 - Flexural Rigidity | 802 | 782 | 742 |
| (EI, 475) | | | |
| LOI (%) | 15.1 | 16.3 | 14.6 |
| Avg. Fiber Diameter (μm)* | 12 | 12.9 | 11.7 |
| Average Dust (g)* | 0.09 | 0.12 | 0.1 |

SP1 = Phenol-Formaldehyde (PF)
SP2 = Triammonium Citrate/High Fructose Corn Syrup (HFCS-42)
SP3 = Diammonium Phosphate/High Fructose Corn Syrup (HFCS-42)
*Not standardized test

While certain embodiments of the present invention have been described and/or exemplified above, it is contemplated that considerable variation and modification thereof are possible. Accordingly, the present invention is not limited to the particular embodiments described and/or exemplified herein.

1. A method of fabricating a thermal or acoustical insulation product, the method comprising:
cutting the thermal or acoustical insulation product with a single cutting blade, wherein the insulation product maintains a cutability rating of about 1 to about 2; and
forming the cut thermal or acoustical insulation product into a desired structure or space,
wherein the thermal or acoustical insulation product comprises:
(a) a collection of glass fibers, the glass fibers being present in the insulation product in the range from about 80% by weight to about 99% by weight; and
(b) a cured, formaldehyde-free binder disposed on the collection of glass fibers, wherein the cured binder comprises i) at least one Maillard reaction product of a carbohydrate reactant and an amine reactant, wherein the carbohydrate reactant is selected from one or more carbohydrate reactants having one or more reducing sugars, one or more carbohydrate reactants which yield one or more reducing sugars in situ under thermal curing conditions, and combinations thereof, wherein the amine reactant is selected from an ammonium salt of one or more monomeric polycarboxylic acids, an ammonium salt of one or more polymeric polycarboxylic acids, and combinations thereof, and wherein the percent by dry weight of the reducing sugar from the carbohydrate reactant with respect to the total weight of reactants ranges from about 73% to about 96%, ii) a silicon-containing coupling agent, and iii) optionally, a corrosion inhibitor,
and wherein the thermal or acoustical insulation product has a density of from about 0.4 lbs/ft³ to about 6 lbs/ft³.

2. The method of claim 1, wherein the thermal or acoustical insulation product is selected from the group consisting of air duct board, duct liner, and pipe insulation.

3. The method of claim 1, wherein the cutability rating of about 1 to about 2 is maintained over at least about 40,000 linear cut feet.

4. The method of claim 1, wherein the single cutting blade is a GlassMaster® blade.

5. The method of claim 1, wherein the single cutting blade maintains a durability, wearability and/or longevity comparable to a single cutting blade used to cut a thermal or acoustical insulation product comprising a collection of glass fibers and a cured, phenol-formaldehyde binder.

6. The method of claim 1, where the ratio of mean weathered tensile strength to mean dry tensile strength for the thermal or acoustical insulation product is in the range from about 0.7 to about 1.

7. The method of claim 1, wherein the amine reactant comprises an ammonium salt of a monomeric polycarboxylic acid.

8. The method of claim 7, wherein the monomeric polycarboxylic acid is selected from the group consisting of citric acid, aconitic acid, adipic acid, azelaic acid, chlorendic acid, citraconic acid, fumaric acid, glutaric acid, isophthalic acid, itaconic acid, maleic acid, malic acid, mesaconic acid, oxalic acid, phthalic acid, sebacic acid, succinic acid, tartaric acid, terephthalic acid, and trimellitic acid.

9. The method of claim 7, wherein the monomeric polycarboxylic acid is citric acid.

10. The method of claim 1, wherein the carbohydrate reactant includes a monosaccharide reducing sugar.

11. The method of claim 10, wherein the monosaccharide reducing sugar is selected from the group consisting of erythrose, threose, erythrulose, ribose, arabinose, lyxose, ribulose, arabulose, xylulose, lyxulose, mannose, galactose, allose, altrose, talose, gulose, psicose, sorbose, tagatose, and sedoheptulose.

12. The method of claim 10, wherein the monosaccharide reducing sugar is selected from the group consisting of dextrose, xylose, fructose, and dihydroxyacetone.

13. The method of claim 10, wherein the monosaccharide reducing sugar comprises dextrose.

14. The method of claim 1, wherein the carbohydrate reactant comprises a carbohydrate selected from the group consisting of a pentose, a pentose used in combination with other reducing sugars, xylose, xylose used in combination with other reducing sugars, a hexose, a hexose used in combination with other reducing sugars, dextrose, dextrose used in combination with other reducing sugars, fructose, fructose used in combination with other reducing sugars, sucrose, and sucrose used in combination with monosaccharides.

15. The method of claim 1, wherein the carbohydrate reactant comprises one or more carbohydrate reactants which yield one or more reducing sugars in situ under thermal curing conditions selected from the group consisting of sucrose, lactose, maltose, starch, and cellulose.

16. The method of claim 1, wherein the silicon-containing coupling agent is amino-substituted.

17. The method of claim 1, wherein the silicon-containing coupling agent is a silyl ether.

18. The method of claim 1, wherein the silicon-containing coupling agent includes at least one of gamma-aminopropyltriethoxysilane, gamma-glycidoxypropyltrimethoxysilane, aminoethylaminopropyltrimethoxysilane, and n-propylamine silane.

19. The method of claim 1, wherein the cured binder comprises a corrosion inhibitor.

20. The method of claim 19, wherein the corrosion inhibitor is selected from at least one of the group consisting of dedusting oil, monoammonium phosphate, sodium metasilicate pentahydrate, melamine, tin(II)oxalate, and a methylhydrogen silicone fluid emulsion.

21. The method of claim 1, wherein the cured binder disposed on the collection of glass fibers is dehydrated and subsequently cured.

22. The method of claim 1, wherein the cured binder disposed on the collection of fibers is a substantially water-insoluble thermoset resin.

23. The method of claim 1, wherein the cured binder disposed on the collection of glass fibers comprises water-insoluble melanoidins.

24. The method of claim 7, wherein the ammonium salt includes an ammonium ion selected from the group consisting of ⁺NH₄, ⁺NH₃R¹ and ⁺NH₂R¹R², wherein R¹ and R² are each independently selected in ⁺NH₂R¹R², R¹ is alkyl which is substituted by at least one group selected from aminoalkyl, amide, nitrile, amino, dialkylamino, acylamino and combinations thereof, and wherein R₂ is selected from alkyl, cycloalkyl, alkenyl, cycloalkenyl, heterocyclyl, aryl, and heteroaryl, each of which may be optionally substituted.

25. The method of claim 24, wherein the ammonium ion is ⁺NH₄.

26. The method of claim 25, wherein the wherein the monomeric polycarboxylic acid is citric acid and the carbohydrate reactant is high fructose corn syrup (HFCS-42).

27. The method of claim 1, wherein the amine reactant comprises an ammonium salt of one or more monomeric polycarboxylic acids, wherein the ammonium salt includes an ammonium ion ⁺NH₃R¹, wherein R¹ is alkyl which is substituted by at least one group selected from aminoalkyl, amido, nitrile, amino, dialkylamino, acylamino and combinations thereof.

28. The method of claim 1, wherein the amine reactant comprises an ammonium salt of one or more monomeric polycarboxylic acids, wherein the ammonium salt includes an ammonium ion ⁺NH₃R¹, wherein R¹ is selected from alkyl, cycloalkyl, alkenyl, cycloalkenyl, and heterocyclyl, each of which is substituted by at least one group selected from aminoalkyl, amide, nitrile, amino, dialkylamino, acylamino and combinations thereof.

29. The method of claim 1, wherein the cured binder disposed on the collection of glass fibers consists essentially of i) at least one Maillard reaction product of a carbohydrate reactant and an amine reactant and ii) a silicon-containing coupling agent.

30. The method of claim 1, wherein the cured binder disposed on the collection of glass fibers consists of i) at least one Maillard reaction product of a carbohydrate reactant and an amine reactant and ii) a silicon-containing coupling agent.

31. A thermal or acoustical insulation product fabricated according to the method of claim 1.
